(19) United States
(12) Patent Application Publication
(10) Pub. No.: US 2026/0087161 A1
(43) Pub. Date: Mar. 26, 2026

(54) GRANULE PROTECTION CHECKING

(71) Applicant: Arm Limited, Cambridge (GB)

(72) Inventors: Abdel Hadi MOUSTAFA, Nice (FR); Paolo MONTI, Quattordio (IT); Guillaume BOLBENES, Vallauris (FR); Albin Pierrick TONNERRE, Nice (FR); . ABHISHEK RAJA, Niagara Falls, NY (US)

(21) Appl. No.: 18/894,651

(22) Filed: Sep. 24, 2024

(51) Int. Cl. G06F 21/62; G06F 12/0862; G06F 12/1009

(52) U.S. Cl. CPC G06F 21/6218; G06F 12/0862; G06F 12/1009

(57) ABSTRACT

An apparatus, comprises granule protection checking circuitry to obtain granule protection information associated with a target granule of physical addresses comprising a target physical address, and determine, based on the granule protection information, whether a selected physical address space associated with the target physical address is permitted to access the target granule of physical addresses. The apparatus comprises prefetch circuitry configured to initiate a prefetch operation for the target physical address enabling target data identified by the target physical address to be prefetched into a cache in advance of the granule protection checking circuitry determining whether the selected physical address space is permitted to access the target granule of physical addresses.

### BACKGROUND

### Technical Field

The present technique relates to the field of data processing.

### Technical Background

A data processing system may have circuitry for restricting access to particular locations in a memory system. In particular, it may be desired to prevent at least some software processes executing on a data processing system from accessing memory locations associated with particular physical addresses. This can allow different software processes, having different security requirements, to operate on the same data processing system whilst reducing the risk of data being leaked between those software processes.

### SUMMARY

At least some examples of the present technique provide an apparatus, comprising:
granule protection checking circuitry configured to:
   perform a granule protection lookup based on a target physical address to obtain granule protection information associated with a target granule of physical addresses comprising the target physical address; and
   determine, based on the granule protection information, whether a selected physical address space associated with the target physical address and selected from among a plurality of physical address spaces is permitted to access the target granule of physical addresses; and
prefetch circuitry configured to initiate a prefetch operation for the target physical address enabling target data identified by the target physical address to be prefetched into a cache in advance of the granule protection checking circuitry determining whether the selected physical address space is permitted to access the target granule of physical addresses.

At least some examples provide a method, comprising:
performing a granule protection lookup based on a target physical address to identify granule protection information associated with a target granule of physical addresses comprising the target physical address;
determining, based on the granule protection information, whether a selected physical address space associated with the target physical address and selected from among a plurality of physical address spaces is permitted to access the target granule of physical addresses; and
initiating, in advance of the granule protection checking circuitry determining whether the selected physical address space is permitted to access the target granule of physical addresses, a prefetch operation for the target physical address enabling target data identified by the target physical address to be prefetched into a cache.

At least some examples provide computer-readable code for fabrication of an apparatus, comprising:
granule protection checking circuitry configured to:
   perform a granule protection lookup based on a target physical address to identify granule protection information associated with a target granule of physical addresses comprising the target physical address; and
   determine, based on the granule protection information, whether a selected physical address space associated with the target physical address and selected from among a plurality of physical address spaces is permitted to access the target granule of physical addresses; and
prefetch circuitry configured to initiate a prefetch operation for the target physical address enabling target data identified by the target physical address to be prefetched into a cache in advance of the granule protection checking circuitry determining whether the selected physical address space is permitted to access the target granule of physical addresses.

The computer-readable code may be stored on a computer-readable medium, which may be a non-transitory computer-readable medium.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing apparatus;

FIG. 2 schematically illustrates an example of a data processing system having at least one requester device and at least one completer device;

FIG. 3 illustrates the concept of aliasing of the respective physical address spaces (PASs) onto physical memory;

FIG. 4 illustrates how a system physical address space can be divided into chunks allocated for access within a particular architectural physical address space;

FIG. 5 is a flow diagram showing how to determine a current domain of operation;

FIG. 6 shows an example of page table entry formats;

FIG. 7 is a flow diagram showing a method of selecting a PAS based on a current domain and information from a page table entry used in generating the physical address for a given memory access request;

FIGS. 8 to 11 provide examples of a prefetchable cache line buffer which can be used to initiate a plurality of prefetch requests;

FIG. 12 is a flow diagram illustrating a method of issuing prefetch requests for memory locations protected by granule protection checking circuitry;

FIG. 13 is a flow diagram illustrating a method performed by address translation circuitry comprising prefetch circuitry in response to a demand access request;

FIG. 14 is a flow diagram illustrating a method performed by address translation circuitry in response to a prefetch request;

FIG. 15 is a flow diagram illustrating a method performed by address translation circuitry without prefetch circuitry, in response to a demand access request;

FIG. 16 is a flow diagram illustrating a method performed by a requester issuing a demand access request to address translation circuitry having prefetch circuitry;

FIG. 17 is a flow diagram illustrating a method performed by a requester issuing a demand access request to address translation circuitry which does not have prefetch circuitry;

FIG. 18 is a flow diagram illustrating a method performed by a prefetch engine issuing a prefetch request;

FIG. 19 is a flow diagram illustrating a method of issuing prefetch requests to a set of target physical addresses using a prefetchable cache line buffer; and

FIG. 20 illustrates a system and a chip-containing product.

### DESCRIPTION OF EXAMPLES

An apparatus comprises granule protection checking circuitry configured to perform a granule protection lookup based on a target physical address to obtain granule protection information associated with a target granule of physical addresses comprising the target physical address. The granule protection checking circuitry is configured to determine, based on the granule protection information, whether a selected physical address space associated with the target physical address and selected from among a plurality of physical address spaces is permitted to access the target granule of physical addresses.

Hence, a system may provide a plurality of physical address spaces, and physical addresses (e.g., specified by memory access requests) may be associated with one of the plurality of physical address spaces. The granule protection checking circuitry can determine based on the granule protection information whether a particular physical address space is permitted to access a particular target physical address. This can allow control over which software processes are allowed to access particular locations in memory, because the hardware may restrict which physical address spaces are permitted to be used by software processes when accessing memory. Hence, a software process may be unable to access a particular memory location identified by a target physical address if it is unable to specify a physical address in a physical address space permitted to access that target physical address.

A physical address may be associated with a physical address space in various ways. For example, one or more bits of a physical address (e.g., a portion not used for identifying a location in memory) may indicate which physical address space is associated with that physical address. The granule protection lookup may be performed in a granule protection table (GPT) stored in memory. However, in some examples, one or more portions of the GPT, such as particular items of granule protection information (GPI) may be cached in locations which are faster to access than memory, and hence the lookup may also or alternatively be performed in a cache structure.

The GPI may be specified for granules (e.g., contiguous blocks) of physical addresses all able to be accessed via the same physical address spaces. It will be appreciated that for the purposes of the present invention, the details (e.g., size) of the granule of physical addresses is not particularly limited. The size of a granule may be configurable, such as 4 KB (e.g., the same size as a memory page), 16 KB, or 64 KB, for example.

Physical addresses specified in a physical address space not permitted to access a target physical address are therefore prevented from accessing the data stored at the target physical address. This can provide a strong hardware enforced barrier to prevent certain software processes accessing data they are not permitted to access. Hence, one might think that accesses to memory must be delayed until after the granule protection checking circuitry has determined whether or not the selected physical address space associated with the target physical address is permitted to access the target granule of physical addresses, as otherwise there might be a risk that data is accessed by a process which should not be able to access that data.

However, the present inventors have realised that requiring the granule protection check to complete in advance of initiating any memory accesses may contribute to a high latency for accessing memory protected by the granule protection checking circuitry.

One approach to overcome this problem may be to allow the target data to be obtained before the granule protection check has completed, but prevent the target data from being used until it is known whether the selected physical address space associated with the target physical address is permitted to access the target granule of physical addresses. However, this approach may require the addition of complex logic to track the status of items of data and prevent data being used until a granule protection check has passed for that data.

According to examples of the present technique, the apparatus comprises prefetch circuitry configured to initiate a prefetch operation for the target physical address enabling target data (where it will be appreciated that the target data may include instructions or data) identified by the target physical address to be prefetched into a cache in advance of the granule protection checking circuitry determining whether the selected physical address space is permitted to access the target granule of physical addresses. As will be discussed below, the prefetch circuitry is not particularly limited, and in various examples the prefetch circuitry may be provided by different system components.

The inventors have realised that performance may be significantly improved if a prefetch operation to fetch the target data into a cache can be initiated (and in some cases completed) even before the granule protection check has completed. In particular, this allows the latency of obtaining the target data (which may be long if the data is stored in memory) to be overlapped with the time taken to perform the granule protection check (by performing the granule protection lookup and determining whether the selected physical address space is permitted to access the target physical address).

The inventors have also realised that performing an operation to access the target data from memory may not increase the risk of the target data being made available to a software process which should not have access to that data, even without addition of a further tracking mechanism, as long as the data is only prefetched into a cache. For example, mechanisms may be provided which prevent data in the cache from being accessed by a software process until after the granule protection check has been completed.

Therefore, providing prefetch circuitry to initiate the prefetch operation at a timing independent of whether the granule protection circuitry has yet determined whether the selected physical address space is permitted to access the target granule of physical addresses can enable performance to be improved without reducing security or requiring the addition of complex logic.

In some examples, the target physical address associated with the target physical address space may be directly specified in an access request for accessing memory. However, in some examples, the apparatus may comprise address translation circuitry responsive to a memory access request specifying a target virtual address to translate the target virtual address into the target physical address associated with the selected physical address space. The mappings between virtual addresses and physical addresses may be defined in one or more page table structures. The page table entries within the page table structures could also define some access permission information which may control whether a given software process executing on the processing circuitry is allowed to access a particular address.

In some alternative processing systems, all virtual addresses may be mapped by the address translation circuitry onto a single physical address space which is used by the memory system to identify locations in memory to be accessed. In such a system, control over whether a particular software process can access a particular address is provided solely based on the page table structures used to provide the virtual-to-physical address translation mappings. However, such page table structures may typically be defined by an operating system and/or a hypervisor. If the operating system or the hypervisor is compromised then this may cause a security leak where sensitive information may become accessible to an attacker.

Therefore, for some systems where there is a need for certain processes to execute securely in isolation from other processes, supporting translation from a target virtual address to a target physical address associated with a selected physical address space in the plurality of distinct physical address spaces (PASs) can allow a further level of control over memory protection to be implemented beyond that provided by the page table structures. In some examples, for at least some components of the memory system, memory access requests whose virtual addresses are translated into physical addresses in different PASs can be treated as if they were accessing completely separate addresses in memory, even if the physical addresses in the respective PASs actually correspond to the same location in memory. By isolating accesses from different domains of operation of the processing circuitry into respective distinct PASs as viewed for some memory system components, this can provide a stronger security guarantee which does not rely on the page table permission information set by an operating system or hypervisor.

In some examples, the address translation circuitry (e.g., a memory management unit (MMU)) may be responsive to a demand memory access request, the demand memory access request requesting that the target data associated with the target virtual address is returned to a requester, to control the prefetch circuitry to initiate the prefetch operation for the target physical address.

Hence, the address translation circuitry is one example of prefetch circuitry, and may trigger the prefetch operation in response to a demand memory access request. In some examples, the address translation circuitry may trigger the prefetch operation only if the access permission information defined in the page table entry indicates that the software process is allowed to access the target virtual address, although it is noted that this does not provide any information about whether the granule protection information will indicate that the selected physical address space is permitted to access the target granule of physical addresses or not.

The skilled person may find it unusual to issue a prefetch operation in response to a demand access request, as a prefetch request may appear redundant if a demand access request has already been issued. However, until it has been determined whether the selected physical address space is permitted to access the target granule of physical addresses it may not be possible to continue with the demand access request without increasing the risk that the target data might be made available to a software process which should not have access to the target data. Issuing the prefetch operation may however enable the target data to be retrieved from memory (if necessary), allowing the target data to be obtained more quickly in future (e.g., by the demand access request) if it is determined that the selected physical address space is permitted to access the target granule of physical addresses, without increasing the risk of the target data being leaked. Hence, when a target physical address is protected by granule protection circuitry, issuing a prefetch operation in response to the demand access request may counter-intuitively enable performance to be improved.

In some examples, the granule protection information could be cached in a translation lookaside buffer (TLB) alongside cached address translation information. When a target virtual address does not have a valid TLB entry, then it often takes longer to access that data as a page table walk may be required to obtain address translation information, and it may be more likely for the target data not to be cached (and hence require the target data to be retrieved from memory). When a target virtual address does not have a TLB entry, then it may also be slower to access the granule protection information (which may have otherwise been cached in that TLB entry). Hence, it may often be the case that when a long granule protection lookup is required, this coincides with the process of retrieving the target data from memory also taking longer. Requiring the granule protection check to complete before accessing the target data in memory may therefore have a pronounced performance impact when the target virtual address does not have a valid TLB entry. Hence, providing prefetch circuitry to allow the process of obtaining the granule protection information to be overlapped with retrieving the target data from memory can enable performance to be improved significantly. The present techniques can hence enable the latency of TLB misses to be hidden behind the granule protection lookup.

In some examples, the granule protection checking circuitry may be configured to prohibit the target data being returned to the requester in response to determining that the selected physical address space is not permitted to access the target granule of physical addresses. Hence, the granule protection checking circuitry may prevent the target data being accessed by a software process which issues a demand access request for which the selected physical address space is not permitted to access the target granule of physical addresses.

In some examples, the address translation circuitry may provide an address translation response in response to the demand access request. The demand access request may be received by the address translation circuitry, and in response the address translation circuitry may provide a physical address translation and the result of the granule protection check back to the requester, on the basis of which the requester may access the target data in memory. The outcome of the granule protection check may indicate whether the selected physical address space is permitted to access the target granule of physical addresses. In examples discussed below, the address translation circuitry may also provide a translation for a prefetch request. The address translation circuitry may be configured to provide the address translation response at different times for the prefetch request and for the demand access request.

By configuring the address translation circuitry itself to initiate the prefetch operation, this can improve performance without any modification to external requesters responsible for issuing demand access requests. The data may be obtained faster by the external requesters, but the address translation response may appear the same to the external requesters.

In some examples, the address translation circuitry may be configured to provide the prefetch circuitry with one or more offset bits identifying an offset of the target physical address within a memory page. Address translation circuitry may perform address translation at the granularity of a memory page. For example, virtual addresses may be defined by a virtual page address and an offset, where the offset indicates the virtual address within a target page of virtual memory defined by the virtual page address. Address translation circuitry may indicate a physical page corresponding to the virtual page, and the target physical address may be determined by applying the same offset in the target physical page as in the target virtual page, meaning that the address translation itself may only be carried out for the page address. Hence, the target virtual address may typically be specified to the address translation circuitry at the granularity of a memory page (e.g., down to bit 12, where only the virtual page address is specified), because it is only the page address which is translated. Therefore, it would be unusual for address translation circuitry to specify a translated physical address including offset bits. However, in the techniques discussed above the address translation circuitry may initiate the prefetch operation for a target physical address. If the prefetch operation is initiated at the page granularity, then an entire memory page may need to be cached to ensure that the target data is prefetched, but this may require an unnecessarily large amount of storage. Hence, the prefetch operation may require the target physical address to be specified at a cache line granularity. Therefore, in some examples the address translation circuitry may be configured to support also receiving the offset bits (e.g., bits 12-6) for a target virtual address in a translation request, propagating the offset bits to a translated target physical address, and providing the offset bits for the prefetch operation. The requester may also be configured to provide the offset bits in a request to the address translation circuitry to allow the address to be computed for prefetching by the address translation circuitry.

In some examples, the apparatus may comprise a prefetchable cache line buffer configured to store a plurality of prefetchable cache line entries. The prefetchable cache line entries may identify, for a given demand memory access request pending translation, at least an offset portion of a given target virtual address specified by the given demand memory access request, the offset portion identifying an offset of the given target virtual address within a memory page, and memory page identifying information for associating prefetchable cache line entries for which the target virtual addresses belong to the same memory page. The address translation circuitry may be configured to initiate a plurality of prefetch operations to a set of target physical addresses determined based on the offset portion of target virtual addresses identified, based on the memory page identifying information, as corresponding to the same memory page.

Therefore, the information provided within prefetchable cache line entries can allow the prefetch circuitry to determine which pending translation requests have virtual addresses in the same virtual memory page, and prefetch operations may be triggered for the set of physical addresses in the same physical memory page. Each address to be accessed may be calculated by adding the offsets provided by the prefetchable cache line buffer to a base physical page address determined by translating the virtual page address (which has been determined to be the same for each of the set of physical addresses).

By triggering prefetch operations for a set of physical addresses in the same physical memory page, this can enable prefetch operations to be performed more efficiently. It may be more efficient to perform a series of accesses to a particular physical memory page in one go, and hence it can be more efficient to combine all pending requests to a particular physical memory page. In addition, by tracking and only prefetching the lines which have actually received an access request, this can reduce storage compared to prefetching the whole physical memory page.

It may often be the case that several translation requests are received for the same page (e.g., when the MMU is performing a table walk). Whilst the first received request is still pending, the later requests will miss in the TLB as the translation has not yet been performed and will hence also be added to the queue of pending translation requests. By tracking these requests in the prefetchable cache line buffer and issuing the requests corresponding to the same page together, the address translation circuitry may perform the series of prefetch operations more efficiently. In some examples, the prefetchable cache line entries may provide the virtual address of the corresponding access request at a cache line granularity (e.g., down to bit 6). This would serve to provide both the offset portion of the target virtual address (bits 12 to 6) and the memory page identifying information, which could be provided by the virtual page bits of the target virtual address (e.g., the address down to bit 12), as the virtual page bits would match for prefetchable cache line entries belonging to the same memory page.

In other examples, the full virtual memory page address may not be provided by the prefetchable cache line entries. As the address translation circuitry may already know the virtual page address for the request (e.g., from a translation request queue), all that is required is that the prefetchable cache line buffer identifies which other pending requests are in the same page, not where that page is. Therefore, in some examples the memory page identifying information may comprise an identifier assigned to a particular virtual page, so that each request in the same virtual page can be identified for grouping with other requests in the same page, whilst reducing the number of bits stored by the prefetchable cache line buffer.

In some examples, the address translation circuitry may comprise a prefetch disabled mode in which the address translation circuitry is configured to suppress controlling the prefetch circuitry to initiate the prefetch operation. There may be certain workloads where issuing prefetches for demand access requests may not be efficient. For example, if it is found that after initiating prefetch operations, there is a high rate of the granule protection check determining that the target physical address space was not permitted to access the target physical address (frequent granule protection faults), then (although this does impact security) it may be determined that continuing to initiate prefetch operations is not efficient and hence the address translation circuitry may enter the prefetch disabled mode. Likewise, if the demand access requests are issued speculatively and it is found that the speculation is regularly incorrect, then the address translation circuitry may be caused to enter the prefetch disabled mode to reduce the number of initiations of unnecessary prefetch operations.

In some examples, the address translation circuitry may be configured to indicate to the prefetch circuitry whether the demand memory access request is a load request or a store request when controlling the prefetch circuitry to initiate the prefetch operation for the target physical address. A requester may therefore also indicate to the address translation circuitry whether the demand access request is a load request or a store request. This information may also be stored in the prefetchable cache line buffer discussed above.

It can be useful when triggering a prefetch operation for the address translation circuitry to know whether the demand access is a load request or a store request. In particular, this can allow data to be prefetched in different coherency states depending on the type of demand access request. If the target data is requested in a load request then it is unlikely to be modified and hence the target data may be requested in a shared coherency state. In contrast if the target data is requested in a store request then the data is going to be modified and hence the target data may be requested in a unique coherency state (invalidating the copies held by other sharers). If the request type were not known, then all prefetch operations may be performed by requesting unique copies of data in case the data needs to be modified, whereas indicating the request type allows data to be requested in the shared state for load requests. Requesting data in a shared coherency state for load requests can, compared to requesting all data in the unique state, reduce a number of unnecessary invalidations for other copies of the target data which may be held elsewhere in the system.

As discussed above, in some examples, the address translation circuitry may be configured to initiate a prefetch operation to obtain the target data before it is known whether the selected physical address space is permitted to access the target granule of physical addresses. In some alternative examples, the prefetch operation may be triggered by another element of the system other than the address translation circuitry.

In particular, in some examples, the address translation circuitry may be responsive to a demand memory access request to enable a partial address translation response indicating the target physical address to be returned in advance of the granule protection checking circuitry determining whether the selected physical address space is permitted to access the target granule of physical addresses. The prefetch circuitry may be configured to initiate, based on the partial address translation response, the prefetch operation for the target physical address corresponding to the demand memory access request.

Hence, a requester may issue a demand access request to the address translation circuitry and a response may be provided indicating the translated physical address without indicating whether the selected physical address space is permitted to access the target granule of physical addresses. Prefetch circuitry (e.g., at the requester) could then initiate a prefetch operation using the target physical address indicated by the partial address translation response. The benefits of this approach are similar to the address translation circuitry triggering a prefetch operation, in that the process of retrieving the target data into a cache may begin before it has been determined whether the selected physical address space is permitted to access the target granule of physical addresses, which can improve performance.

Compared to the address translation circuitry triggering the prefetch operation, the approach of providing a partial address translation response means that the triggering of the prefetch operation is no longer invisible to a requester, and handling of the partial address translation response may require modification of the circuitry receiving the response. However, it may be more efficient for an entity other than the address translation circuitry (e.g., a load/store unit, which may already be configured to issue memory access requests) to trigger the prefetch operation, as this may reduce the amount of modification required to elements of the system. For example, this may mean there is less need to propagate offset bits to the address translation circuitry. Hence, providing the partial address translation response may result in fewer overall modifications being required for the system to support triggering of a prefetch operation in advance of the outcome of the granule protection check.

In some examples, the partial address translation response may be cached, e.g., in a translation lookaside buffer (TLB). The cached entry may indicate, for example in a partial address translation field, that the entry is one for which the result of the granule protection check is not known. Hence, demand accesses may not be issued on the basis of a partial translation entry. For example, if a load instruction is received and a lookup in the TLB identifies a partial translation entry, memory access circuitry may issue a prefetch operation to retrieve the target data into a cache rather than returning the target data in response to the load instruction.

In some examples, the address translation circuitry may be responsive to the granule protection checking circuitry determining whether the selected physical address space is permitted to access the target granule of physical addresses to return a granule protection check outcome response, the granule protection check outcome response indicating whether the selected physical address space is permitted to access the target granule of physical addresses. Hence, rather than providing a single address translation response indicating an address translation and the outcome of the granule protection check, the address translation circuitry may instead return a partial address translation response indicating the translated physical address, and a subsequent response indicating the outcome of the granule protection check. By providing the granule protection check outcome response, this can indicate whether the previously returned address translation can be used to return target data to a requester.

For example, if the partial address translation response was cached in a TLB, then the granule protection check outcome response can indicate whether that entry can be upgraded to a normal TLB entry (which may be used to obtain data from memory for a requester) if the granule protection check passed, or invalidated if it is determined that the granule protection check failed. In some examples, the prefetch circuitry may be configured to initiate the prefetch operation speculatively in response to a prediction that the target data will be requested by a future demand memory access request, the prefetch operation comprising a request to retrieve the target data associated with the target physical address into the cache without being returned to a requester. For example, the prefetch circuitry may be provided by a prefetch engine configured to predict, e.g., based on monitoring patterns of memory accesses, which addresses are likely to be accessed in the future and issue prefetch requests so that those predicted future demand accesses may be performed more quickly. As the prefetch request does not involve returning the target data to a requester, then the prefetch request may be permitted to retrieve data from memory before the granule protection check has been completed without compromising security, whilst enabling performance to be improved as the prefetch operations are not unnecessarily delayed by the time taken to perform a granule protection check.

The speculative prefetch request may initially specify the target address as a virtual address or a physical address. If the address is specified as a virtual address, then the prefetch request may be issued to the address translation circuitry to indicate a target physical address from which the target data may be prefetched. The address translation circuitry may be configured to provide an address translation response indicating the address translation and may also be configured to perform a granule protection check, but may provide the address translation response in advance of the granule protection checking circuitry determining whether the selected physical address space is permitted to access the target granule of physical addresses, thereby permitting the prefetch operation to be initiated using the target physical address at a timing independent of whether the granule protection checking circuitry has determined whether the selected physical address space is permitted to access the target granule of physical addresses.

In some examples, the prefetch operation may not be permitted in advance of the granule protection check completing for indirect prefetches.

In some examples, the apparatus may comprise a translation lookaside buffer (TLB) configured to cache address mapping information used by the address translation circuitry for translating the target virtual address into the target physical address, and the granule protection checking circuitry may be configured to perform the granule protection lookup and store the identified granule protection information in the translation lookaside buffer, regardless of whether the prefetch circuitry has initiated the prefetch operation for the target physical address.

For example, even after a partial address translation response has been issued, or an address translation response to a prefetch request has been issued, the granule protection checking circuitry may continue with the granule protection check to determine whether the selected physical address space is permitted to access the target granule of physical addresses. By completing the granule protection check, this can allow the outcome of the granule protection check to be cached in the TLB to be used for handling future memory access requests, even if it was not available in time for handling of an initial memory access request.

In some examples, the apparatus may include a point of physical aliasing (PoPA), which is a point at which aliasing physical addresses from different physical address spaces (PASs) which correspond to the same memory system resource are mapped (de-aliased) to a single physical address uniquely identifying that memory system resource. The memory system may include at least one pre-PoPA memory system component which is provided upstream of the PoPA, which treats the aliasing physical addresses as if they correspond to different memory system resources.

For example, the at least one pre-PoPA memory system component could include a cache which may cache data or program code for the aliasing physical addresses in separate entries, so that if the same memory system resource is requested to be accessed from different PASs, then the accesses will cause separate cache entries to be allocated. Also, the pre-PoPA memory system component could include coherency control circuitry, such as a coherent interconnect, snoop filter, or other mechanism for maintaining coherency between cached information at respective requester devices. The coherency control circuitry could assign separate coherency states to the respective aliasing physical addresses in different PASs. Hence, the aliasing physical addresses are treated as separate addresses for the purpose of maintaining coherency even if they do actually correspond to the same underlying memory system resource. Although on the face of it, tracking coherency separately for the aliasing physical addresses could appear to cause a problem of loss of coherency, in practice this is not a problem because if processes operating in different domains are really intended to share access to a particular memory system resource then they can use the same PAS to access that resource. Another example of a pre-PoPA memory system component may be a memory protection engine which is provided for protecting data saved to off-chip memory against loss of confidentiality and/or tampering. Such a memory protection engine could, for example, separately encrypt data associated with a particular memory system resource with different encryption keys depending on which PAS the resource is accessed from, effectively treating the aliasing physical addresses as if they were corresponding to different memory system resources (e.g. an encryption scheme which makes the encryption dependent on the address may be used, and the PAS identifier may be considered to be part of the address for this purpose).

Regardless of the form of the pre-PoPA memory system component, it can be useful for such a PoPA memory system component to treat the aliasing physical addresses as if they correspond to different memory system resources, as this provides hardware-enforced isolation between the accesses issued to different PASs so that information associated with one domain cannot be leaked to another domain by features such as cache timing side channels or side channels involving changes of coherency triggered by the coherency control circuitry.

It may be possible, in some implementations, for the aliasing physical addresses in the different PASs to be represented using different numeric physical address values for the respective different PASs. This approach may require a mapping table to determine at the PoPA which of the different physical address values correspond to the same memory system resource. However, this overhead of maintaining the mapping table may be considered unnecessary, and so in some implementations it may be simpler if the aliasing physical addresses comprise physical addresses which are represented using the same numeric physical address value in each of the different PASs. If this approach is taken then, at the point of physical aliasing, it can be sufficient simply to discard the PAS identifier which identifies which PAS is accessed using a memory access, and then to provide the remaining physical address bits downstream as a de-aliased physical address.

Hence, the memory system may also include a PoPA memory system component configured to de-alias the plurality of aliasing physical addresses to obtain a de-aliased physical address to be provided to at least one downstream memory system component. The PoPA memory system component could be a device accessing a mapping table to find the dealiased address corresponding to the aliasing address in a particular address space, as described above. However, the PoPA component could also simply be a location within the memory system where a PAS identifier identifying the selected PAS associated with a given memory access is discarded so that the physical address provided downstream uniquely identifies a corresponding memory system resource regardless of which PAS this was provided from. Alternatively, in some cases the PoPA memory system component may still provide the PAS identifier to the at least one downstream memory system component (e.g. for the purpose of enabling completer-side filtering), but the PoPA may mark the point within the memory system beyond which downstream memory system components no longer treat the aliasing physical addresses as different memory system resources, but consider each of the aliasing physical addresses to map the same memory system resource. For example, if a memory controller or a hardware memory storage device downstream of the PoPA receives the PAS identifier and a physical address for a given memory access request, then if that physical address corresponds to the same physical address as a previously seen transaction, then any hazard checking or performance improvements performed for respective transactions accessing the same physical address (such as merging accesses to the same address) may be applied even if the respective transactions specified different PAS identifiers. In contrast, for a memory system component upstream of the PoPA, such hazard checking or performance improving steps taken for transactions accessing the same physical address may not be invoked if these transactions specify the same physical address in different PASs.

In some examples, the apparatus may have PAS selection circuitry to select the selected PAS for the target physical address based on at least one of: a current domain of operation; and information specified in a page table entry that also provides address mapping information used by the address translation circuitry for translating the target virtual address into the target physical address. The PAS selection circuitry could be part of the address translation circuitry, or could be part of the granule protection checking circuitry, for example. Where processing circuitry supports different domains of operation, the selection of the selected PAS may depend on the current domain of the processing circuitry. It is also possible for different PASs to be accessed from within a single domain, at least for some domains of operation, and in this case information specified in a page table entry can be used to select the selected PAS to be used for a given memory access request.

In one particular example, processing circuitry may process instructions in one of a plurality of domains of operation and those domains may include at least a non-secure domain, a secure domain, a realm domain and a root domain. In this case, the PASs may comprise:
a root PAS selectable as the selected PAS when a current domain of the processing circuitry is the root domain (the root PAS may be prohibited from being selected as the selected PAS when the current domain is the secure domain, the realm domain or the root domain);
a non-secure PAS selectable as the selected PAS when the current domain of the processing circuitry is any of the non-secure domain, the secure domain, the realm domain and the root domain;
a secure PAS selectable as the selected PAS when the current domain of the processing circuitry is the secure domain or the root domain (the secure PAS may be prohibited from being selected as the selected PAS when the current domain is the non-secure domain or the realm domain); and
a realm PAS selectable as the selected PAS when the current domain of the processing circuitry is the realm domain or the root domain (the realm PAS may be prohibited from being selectable as the selected PAS when the current domain is the non-secure domain or the secure domain).

This approach of having a root domain which can access all of the PASs, a non-secure domain which can access only its non-secure PAS, and secure and realm PASs which can both access the non-secure PAS and its own PAS but cannot access each other's PAS or the root PAS, can be useful to allow multiple mutually distrusting parties to implement code on a shared hardware platform while each being provided with some hardware-enforced guarantees that protect their code and data from access by other code operating on the same system while not being able to access each other's code and data.

Particular examples will now be described with reference to the Figures.

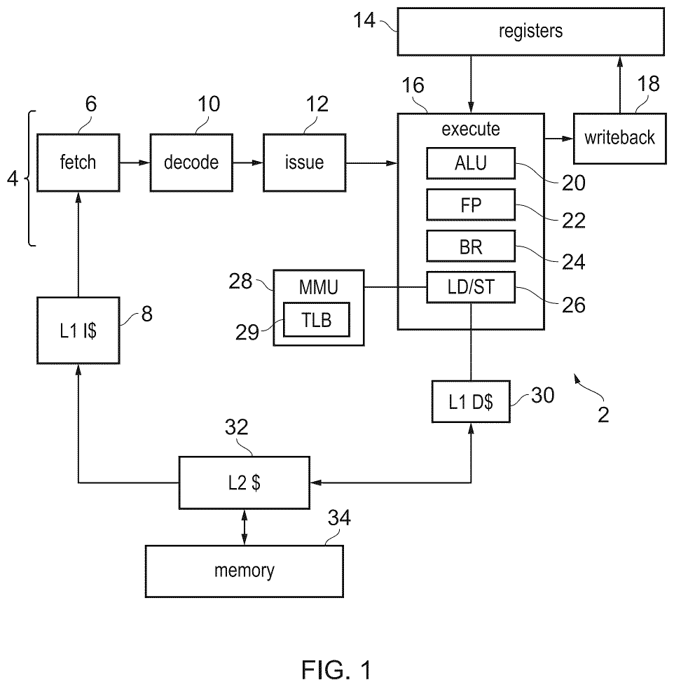

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34. A memory management unit (MMU) 28 is provided for performing address translations between virtual addresses specified by the load/store unit 26 based on operands of data access instructions and physical addresses identifying storage locations of data in the memory system. The MMU has a translation lookaside buffer (TLB) 29 for caching address translation data from page tables stored in the memory system, where the page table entries of the page tables define the address translation mappings and may also specify access permissions which govern whether a given process executing on the pipeline is allowed to read, write or execute instructions from a given memory region.

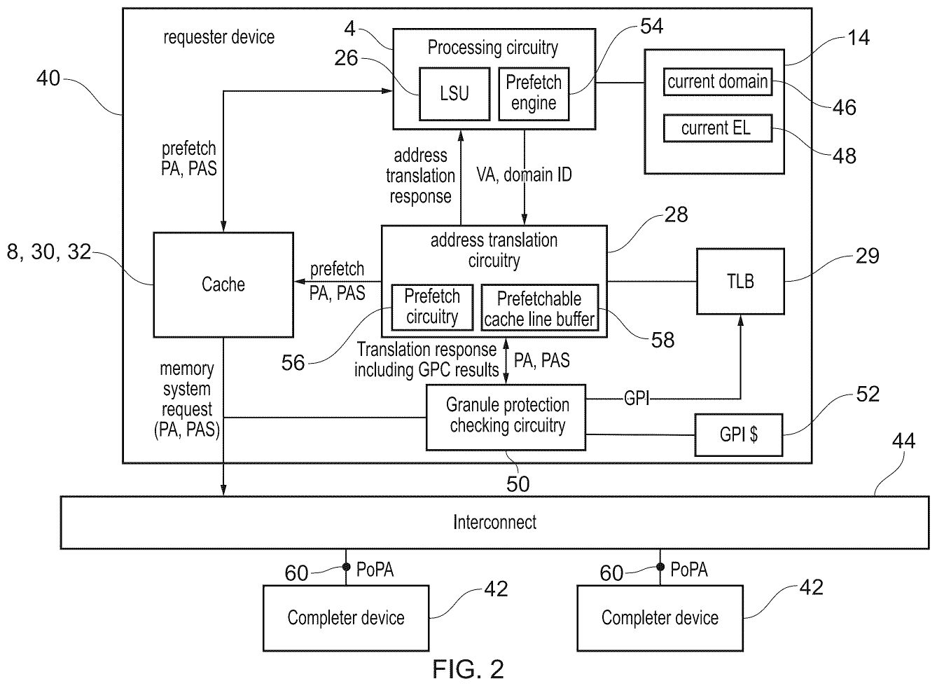

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness. FIG. 2 schematically illustrates an example of a data processing system having at least one requester device 40 and at least one completer device 42. An interconnect 44 provides communication between the requester devices 40 and completer devices 42. A requester device is capable of issuing memory access requests requesting a memory access to a particular addressable memory system location. A completer device 42 is a device that has responsibility for servicing memory access requests directed to it. Although not shown in FIG. 2, some devices may be capable of acting both as a requester device and as a completer device. The requester devices 40 may for example include processing elements such as a central processing unit (CPU) or graphics processing unit (GPU) or other master devices such as bus master devices, network interface controllers, display controllers, etc. A requester device 40 may for example be provided as the data processing apparatus shown in FIG. 1. The completer devices 42 may include memory controllers responsible for controlling access to corresponding memory storage units, peripheral controllers for controlling access to a peripheral device, etc. FIG. 2 shows an example configuration of one of the requester devices 40 in more detail but it will be appreciated that other requester devices 40 could have a similar configuration.

The requester device 40 has processing circuitry 4 (e.g., a pipeline as shown in FIG. 1) for performing data processing in response to instructions, with reference to data stored in registers 14. The registers 14 may include general purpose registers for storing operands and results of processed instructions, as well as control registers for storing control data for configuring how processing is performed by the processing circuitry. For example the control data may include a current domain indication 46 used to select which domain of operation is the current domain, and a current exception level indication 48 indicating which exception level is the current exception level in which the processing circuitry 4 is operating. While FIG. 2 shows the current domain indication 46 and current exception level indication 48 as distinct status values, it is also possible that the current domain and/or exception level may be determined based on a current values of set of multiple control bits stored in one or more control registers, so it is not essential to provide a single distinct status value encoding the current domain or the current exception level. The processing circuitry 4 may be capable of issuing memory access requests specifying a virtual address (VA) identifying the addressable location to be accessed and a domain identifier (Domain ID or ‘security state’) identifying the current domain. The memory access requests may be demand access requests requesting that target data is returned to a register 14, or prefetch requests issued by a prefetch engine 54 requesting that the target data is returned to a cache 30, 32. Address translation circuitry 28 (e.g. a memory management unit (MMU)) translates the virtual address into a physical address (PA) through one of more stages of address translation based on page table data defined in page table structures stored in the memory system. A translation lookaside buffer (TLB) 29 acts as a lookup cache for caching some of that page table information for faster access than if the page table information had to be fetched from memory each time an address translation is required. In this example, as well as generating the physical address, the address translation circuitry 28 also selects one of a number of physical address spaces (PASs) associated with the physical address and outputs a physical address space (PAS) identifier identifying the selected physical address space. Selection of the PAS will be discussed in more detail below.

Granule protection checking circuitry 50 acts as requester-side filtering circuitry for checking, based on a physical address and the PAS identifier, whether that physical address is allowed to be accessed within the specified physical address space identified by the PAS identifier. This lookup is based on granule protection information (GPI) stored in a granule protection table structure stored within the memory system. The granule protection information may be cached within a granule protection information cache 52, similar to a caching of page table data in the TLB 29. While the granule protection information cache 52 is shown as a separate structure from the TLB 29 in the example of FIG. 2, in other examples these types of lookup caches could be combined into a single lookup cache structure, or the GPI may alternatively be cached in the TLB 29. The granule protection information defines information restricting the physical address spaces from which a given physical address can be accessed, and based on this lookup the granule protection checking circuitry 50 determines whether to allow the memory access request to proceed to be issued to one or more caches 8, 30, 32 and/or the interconnect 44. If the specified PAS for the memory access request is not allowed to access the specified physical address then the granule protection checking circuitry 50 blocks the transaction and may signal a fault.

Hence, the processing circuitry 4 may issue a memory access request to the address translation circuitry 28 and receive in response an address translation response including an address translation and an indication from the granule protection checking circuitry 50 of whether the memory access request is allowed to proceed.

While FIG. 2 shows an example of address translation circuitry 28 and granule protection checking circuitry 50 provided within a requester 40, other types of requesters could use address translation functionality provided by a separate system memory management unit (SMMU) which is a separate component from the requester 40 itself. In that case, the SMMU may be coupled to the interconnect and may perform similar functions to those of the address translation circuitry 28 and granule protection checking circuitry 50 shown in FIG. 2, and may have a similar GPI cache 52.

While FIG. 2 shows an example where selection of the PAS for a given request is performed by the address translation circuitry 28, in other examples information for determining which PAS to select can be output by the address translation circuitry 28 to the granule protection checking circuitry 50 along with the PA, and the granule protection checking circuitry 50 may select the PAS and check whether the PA is allowed to be accessed within the selected PAS.

In some examples, the processing circuitry 4 may be capable of issuing memory access requests directly specifying a physical address (PA) identifying the addressable location to be accessed, without memory translation. The granule protection checking circuitry 50 may determine, based on the domain ID associated with the memory access request, which PAS is associated with the requested PA, and may provide a response to the processing circuitry 4 indicating whether the memory access request is allowed to proceed.

The provision of the granule protection checking circuitry 50 helps to support a system which can operate in a number of domains of operation each associated with its own isolated physical address space where, for at least part of the memory system (e.g. for some caches or coherency enforcing mechanisms such as a snoop filter), the separate physical address spaces are treated as if they refer to completely separate sets of addresses identifying separate memory system locations, even if addresses within those address spaces actually refer to the same physical location in the memory system.

For example, the processing circuitry may support a number of domains of operation including a root domain, a secure(S) domain, a less secure domain, and a realm domain. For ease of reference, the less secure domain will be described below as the “non-secure” (NS) domain, but it will be appreciated that this is not intended to imply any particular level of (or lack of) security. Instead, “non-secure” merely indicates that the non-secure domain is intended for code which is less secure than code operating in the secure domain. The current domain may be selected based on a current exception level indicator 48, and/or the current domain indicator 46, which indicates which of the domains is active.

The non-secure domain may be used for regular application-level processing, and for the operating system and hypervisor activity for managing such applications. Hence, within the non-secure domain, there may be application code operating at exception level 0 (EL0), operating system (OS) code operating at EL1 and hypervisor code operating at EL2.

The secure domain may enable certain system-on-chip security, media or system services to be isolated into a separate physical address space from the physical address space used for non-secure processing. The secure and non-secure domains may not be equal, in the sense that the non-secure domain code cannot access resources associated with the secure domain, while the secure domain can access both secure and non-secure resources.

The realm domain may have its own physical address space allocated to it, similar to the secure domain, but the realm domain may be orthogonal to the secure domain in the sense that while the realm and secure domains can each issue memory access requests in the non-secure PAS associated with the non-secure domain, the realm and secure domains cannot access each other's physical address spaces. This means that code executing in the realm domain and secure domains have no dependencies on each other.

The root domain may manage domain switching, and may have its own isolated root physical address space. The creation of the root domain and the isolation of its resources from the secure domain may allow for a more robust implementation even for systems which only have the non-secure and secure domains but do not have the realm domain, but can also be used for implementations which do support the realm domain.

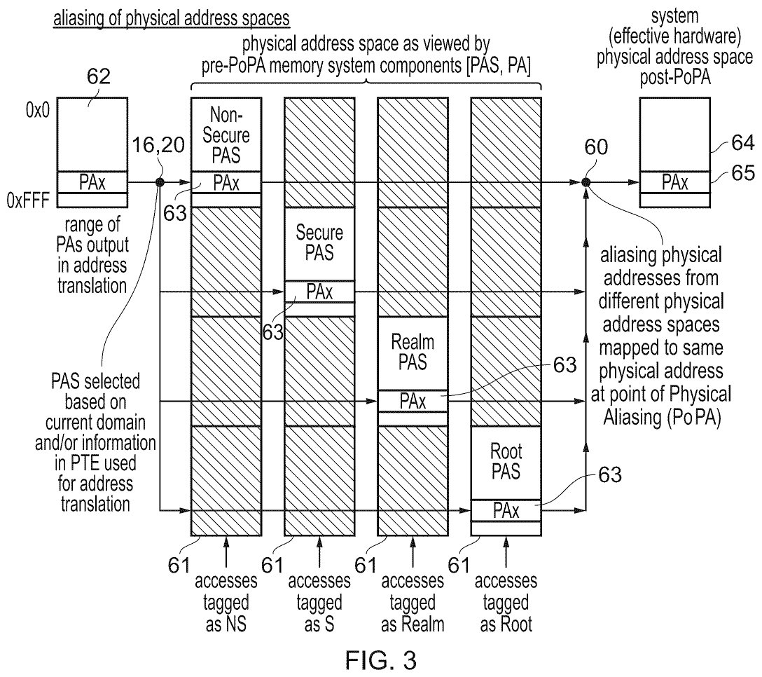

FIG. 3 illustrates the concept of aliasing of the respective physical address spaces (PASs) onto physical memory provided in hardware. As described earlier, each of the domains has its own respective physical address space 61.

At the point when a physical address is generated by address translation circuitry 28, the physical address has a value within a certain numeric range 62 supported by the system, which is the same regardless of which physical address space is selected. However, in addition to the generation of the physical address, the address translation circuitry 28 may also select a particular physical address space (PAS) based on the current domain and/or information in the page table entry used to derive the physical address. Alternatively, instead of the address translation circuitry 28 performing the selection of the PAS, the address translation circuitry (e.g. MMU) could output the physical address and the information derived from the page table entry (PTE) which is used for selection of the PAS, and then this information could be used by the granule protection checking circuitry 50 to select the PAS.

The selection of PAS for a given memory access request may be restricted depending on the current domain in which the processing circuitry 4 is operating when issuing the memory access request.

For example, when the processing circuitry 4 is operating in the Non-Secure domain, only the Non-Secure PAS may be selected for memory access requests issued by the processing circuitry.

When the processing circuitry 4 is operating in the Secure domain, the Non-Secure or Secure PAS may be selected for memory access requests issued by the processing circuitry, but not the Realm PAS or Root PAS.

When the processing circuitry 4 is operating in the Realm domain, the Non-Secure or Realm PAS may be selected for memory access requests issued by the processing circuitry, but not the Secure PAS or Root PAS.

When the processing circuitry 4 is operating in the Root domain, any PAS may be selected for memory access requests issued by the processing circuitry.

For those domains for which there are multiple physical address spaces available for selection, the information from the accessed page table entry used to provide the physical address can be used to select between the available PAS options.

Hence, at the point when the granule protection checking circuitry 50 outputs a memory access request (assuming it passed any filtering checks), the memory access request is associated with a physical address (PA) and a selected physical address space (PAS).

The Point of Physical Aliasing (PoPA) 60 is a location in the system where the PAS ID is stripped and the address changes back from an aliasing address to a system physical address. The PoPA can be located below the caches, at the completer-side of the system where access to the physical DRAM is made (using encryption context resolved through the PAS ID). Alternatively, it may be located above the caches to simplify system implementation at the cost of reduced security. An example of a PoPA is illustrated in FIG. 2, as well as FIG. 3.

From the point of view of memory system components (such as caches, interconnects, snoop filters etc.) which operate before the point of physical aliasing (PoPA) 60, the respective physical address spaces 61 are viewed as entirely separate ranges of addresses which correspond to different system locations within memory. This means that, from the point of view of the pre-PoPA memory system components, the range of addresses identified by the memory access request is actually four times the size of the range 62 which could be output in the address translation, as effectively the PAS identifier is treated as additional address bits alongside the physical address itself, so that depending on which PAS is selected the same physical address PAx can be mapped to a number of aliasing physical addresses 63 in the distinct physical address spaces 61. These aliasing physical addresses 63 all actually correspond to the same memory system location implemented in physical hardware, but the pre-PoPA memory system components treat aliasing addresses 63 as separate addresses. Hence, if there are any pre-PoPA caches or snoop filters allocating entries for such addresses, the aliasing addresses 63 would be mapped into different entries with separate cache hit/miss decisions and separate coherency management. This reduces likelihood or effectiveness of attackers using cache or coherency side channels as a mechanism to probe the operation of other domains.

The system may include more than one PoPA 60. At each PoPA 60, the aliasing physical addresses are collapsed into a single de-aliased address 65 in the system physical address space 64. The de-aliased address 65 is provided downstream to any post-PoPA components, so that the system physical address space 64 which actually identifies memory system locations is once more of the same size as the range of physical addresses that could be output in the address translation performed on the requester side. For example, at the PoPA 60 the PAS identifier may be stripped out from the addresses, and for the downstream components the addresses may simply be identified using the physical address value, without specifying the PAS. Alternatively, for some cases where some completer-side filtering of memory access request is desired, the PAS identifier could still be provided downstream of the PoPA 60, but may not be interpreted as part of the address so that the same physical addresses appearing in different physical address spaces 60 would be interpreted downstream of the PoPA as referring to the same memory system location, but the supplied PAS identifier can still be used for performing any completer-side security checks.

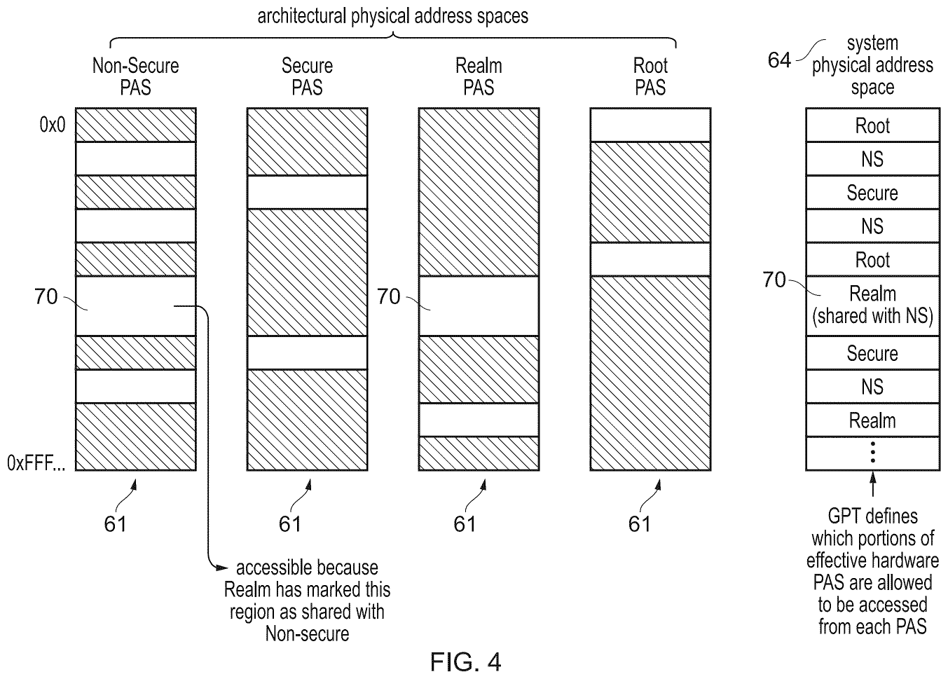

FIG. 4 illustrates how the system physical address space 64 can be divided, using the granule protection table, into chunks allocated for access within a particular architectural physical address space 61. The granule protection table (GPT) defines which portions of the system physical address space 65 are allowed to be accessed from each architectural physical address space 61. For example the GPT may comprise a number of entries each corresponding to a granule of physical addresses of a certain size (e.g. a 4K page) and may define an assigned PAS for that granule, which may be selected from among the non-secure, secure, realm and root domains. By design, if a particular granule or set of granules is assigned to the PAS associated with one of the domains, then it can only be accessed within the PAS associated with that domain and cannot be accessed within the PASs of the other domains. However, note that while a granule allocated to the secure PAS (for instance) cannot be accessed from within the root PAS, the root domain is nevertheless able to access that granule of physical addresses by specifying in its page tables the PAS selection information for ensuring that virtual addresses associated with pages which map to that region of physical addressed memory are translated into a physical address in the secure PAS instead of the root PAS. Hence, the sharing of data across domains (to the extent permitted by the accessibility/inaccessibility rules defined in the table described earlier) may be controlled at the point of selecting the PAS for a given memory access request.

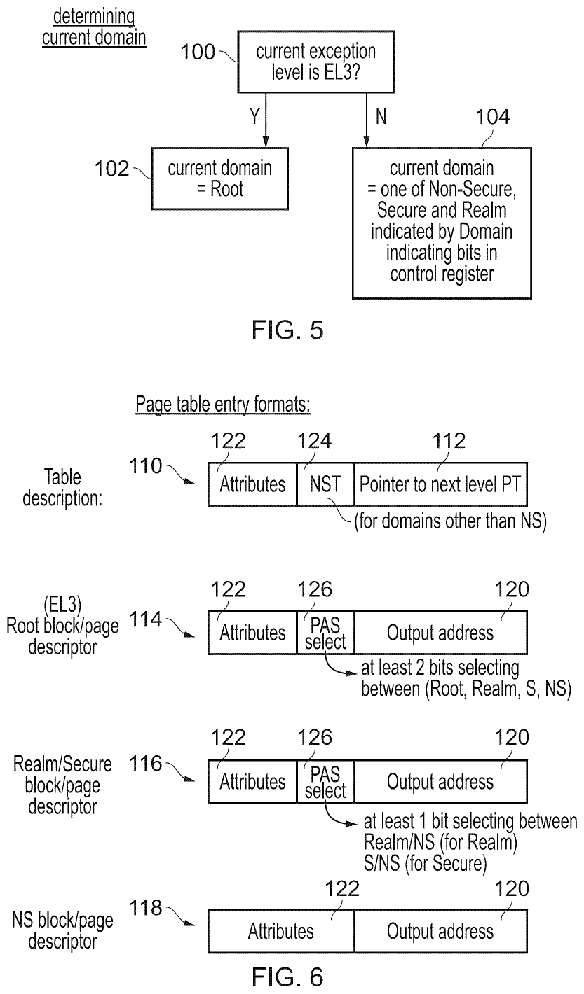

FIG. 5 is a flow diagram showing how to determine the current domain of operation, which could be performed by the processing circuitry 4 or by address translation circuitry 28 or the granule protection checking circuitry 50. At step 100 it is determined whether the current exception level is EL3 and if so then at step 102 the current domain is determined to be the root domain. If the current exception level is not EL3, then at step 104 the current domain is determined to be one of the non-secure, secure and realm domains as indicated by at least two domain indicating bits 46 within an EL3 control register of the processor (as the root domain is indicated by the current exception level being EL3, it may not be essential to have an encoding of the domain indicating bits 46 corresponding to the root domain, so at least one encoding of the domain indicating bits could be reserved for other purposes). The EL3 control register is writable when operating at EL3 and cannot be written from other exception levels EL2-EL0.

FIG. 6 shows an example of page table entry (PTE) formats which can be used for page table entries in the page table structures used by the address translation circuitry 28 for mapping virtual addresses to physical addresses, mapping virtual addresses to intermediate addresses or mapping intermediate addresses to physical addresses (depending on whether translation is being performed in an operating state where a stage 2 translation is required at all, and if stage 2 translation is required, whether the translation is a stage 1 translation or a stage 2 translation). In general, a given page table structure may be defined as a multi-level table structure which is implemented as a tree of page tables where a first level of the page table is identified based on a base address stored in a translation table base address register of the processor, and an index selecting a particular level 1 page table entry within the page table is derived from a subset of bits of the input address for which the translation lookup is being performed (the input address could be a virtual address for stage 1 translations of an intermediate address for stage 2 translations). The level 1 page table entry may be a “table descriptor” 110 which provides a pointer 112 to a next level page table, from which a further page table entry can then be selected based on a further subset of bits of the input address. Eventually, after one or more lookups to successive levels of page tables, a block or page descriptor PTE 114, 116, 118 may be identified which provides an output address 120 corresponding to the input address. The output address could be an intermediate address (for stage 1 translations performed in an operating state where further stage 2 translation is also performed) or a physical address (for stage 2 translations, or stage 1 translations when stage 2 is not needed).

To support the distinct physical address spaces described above, the page table entry formats may, in addition to the next level page table pointer 112 or output address 120, and any attributes 122 for controlling access to the corresponding block of memory, also specify some additional state for use in physical address space selection.

For a table descriptor 110, the PTEs used by any domain other than the non-secure domain includes a non-secure table indicator 124 which indicates whether the next level page table is to be accessed from the non-secure physical address space or from the current domain's physical address space. This helps to facilitate more efficient management of page tables. Often the page table structures used by the root, realm or secure domains may only need to define special page table entries for a portion of the virtual address space, and for other portions the same page table entries as used by the non-secure domain could be used, so by providing the non-secure table indicator 124 this can allow higher levels of the page table structure to provide dedicated realm/secure table descriptors, while at a certain point of the page table tree, the root realm or secure domains could switch to using page table entries from the non-secure domain for those portions of the address space where higher security is not needed. Other page table descriptors in other parts of the tree of page tables could still be fetched from the relevant physical address space associated with the root, realm or the secure domain.

On the other hand, the block/page descriptors 114, 116, 118 may, depending on which domain they are associated with, include physical address space selection information 126. The non-secure block/page descriptors 118 used in the non-secure domain do not include any PAS selection information because the non-secure domain is only able to access the non-secure PAS. However for the other domains the block/page descriptor 114, 116 includes PAS selection information 126 which is used to select which PAS to translate the input address into. For the root domain, EL3 page table entries may have PAS selection information 126 which includes at least 2 bits to indicate the PAS associated with any of the four domains as the selected PAS into which the corresponding physical address is to be translated. In contrast, for the realm and secure domains, the corresponding block/page descriptor 116 need only include one bit of PAS selection information 126 which, for the realm domain, selects between the realm and non-secure PASs, and for the secure domain selects between the secure and non-secure PASs. To improve efficiency of circuit implementation and avoid increasing the size of page table entries, for the realm and secure domains the block/page descriptor 116 may encode the PAS selection information 126 at the same positon within the PTE, regardless of whether the current domain is realm or secure, so that the PAS selection bit 126 can be shared.

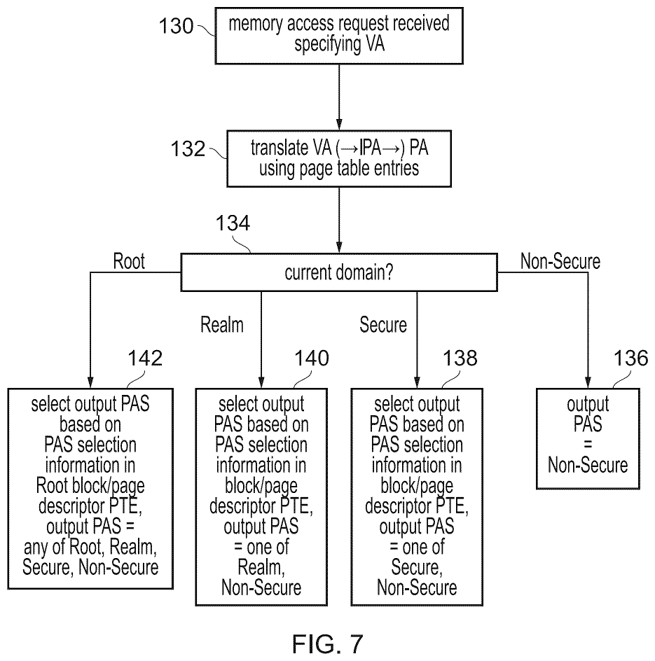

Hence, FIG. 7 is a flow diagram showing a method of selecting the PAS based on the current domain and the information 124, 126 from the block/page PTE used in generating the physical address for a given memory access request. The PAS selection could be performed by the address translation circuitry 28, or if the address translation circuitry forwards the PAS selection information 126 to the granule protection checking circuitry 50, performed by a combination of address translation circuitry 28 and the granule protection checking circuitry 50.

At step 130 in FIG. 7, the processing circuitry 10 issues a memory access request specifying a given virtual address (VA) as a target VA. At step 132 the address translation circuitry 28 looks up any page table entries (or cached information derived from such page table entries) in its TLB 29. If any required page table information is not available, address translation circuitry 28 initiates a page table walk to memory to fetch the required PTEs (potentially requiring a series of memory accesses to step through respective levels of the page table structure and/or multiple stages of address translation for obtaining mappings from a VA to an intermediate address (IPA) and then from an IPA to a PA). Note that any memory access requests issued by the address translation circuitry 28 in the page table walk operations may themselves be subject to address translation and PAS filtering, so the request received at step 130 could be a memory access request issued to request a page table entry from memory. Once the relevant page table information has been identified, the virtual address is translated into a physical address (possibly in two stages via an IPA). At step 134 the address translation circuitry 28 or the granule protection checking circuitry 50 determines which domain is the current domain, using the approach shown in FIG. 5.

If the current domain is the non-secure domain then at step 136 the output PAS selected for this memory access request is the non-secure PAS.

If the current domain is the secure domain, then at step 138 the output PAS is selected based on the PAS selection information 126 which was included in the block/page descriptor PTE which provided the physical address, where the output PAS will be selected as either secure PAS or non-secure PAS.

If the current domain is the realm domain, then at step 140 the output PAS is selected based on the PAS selection information 126 included in the block/page descriptor PTE from which the physical address was derived, and in this case the output PAS is selected as either the realm PAS or the non-secure PAS.

If at step 134 the current domain is determined to be the root domain, then at step 142 the output PAS is selected based on the PAS selection information 126 in the root block/page descriptor PTE 114 from which the physical address was derived. In this case the output PAS is selected as any of the physical address spaces associated with the root, realm, secure and non-secure domains.

Hence, a data processing apparatus provides granule protection checking circuitry to perform a granule protection lookup based on a target physical address to obtain granule protection information associated with a target granule of physical addresses comprising the target physical address, and determine, based on the granule protection information, whether a selected physical address space associated with the target physical address and selected from among a plurality of physical address spaces is permitted to access the target granule of physical addresses.

As discussed earlier, a conventional approach to implementing the granule protection checking circuitry 50 may be to require that the outcome of the granule protection check is known before the target data can be requested from memory, as this can guarantee that the target data can only be accessed by a physical address space which is permitted by the GPT to access that target data.

However, this approach means that the latency of obtaining the target data is added to the latency of performing the granule protection check, which can result in high latency for accesses to an address space protected by the granule protection checking circuitry 50.

In an alternative approach, data could be permitted to be returned to a requester before the outcome of the GPC is known (e.g., the load/store unit 26 or fetch stage 6 may load the target data to registers 14 of a particular requesting device 4 before the GPC outcome is known). This may enable the target data to be accessed more quickly than waiting to obtain the target data until after the GPC. In this alternative approach, a mechanism would need to be implemented to prevent the target data being used by the requester before the outcome of the GPC is known, and invalidate the data if the GPC fails, otherwise the security provided by the GPC could be bypassed. However, providing such a mechanism would require the addition of very complex logic to track which data at a particular requester can be used at a given time and delay operations as necessary, and increase the risk that the data may be used incorrectly. Provision of such logic may be unfeasible if power, performance, and area requirements are to be met.

In the present techniques, the apparatus comprises prefetch circuitry 54, 56 to initiate a prefetch operation for the target physical address enabling target data identified by the target physical address to be prefetched into a cache in advance of the granule protection checking circuitry determining whether the selected physical address space is permitted to access the target granule of physical addresses. This approach also allows the latency of obtaining the target data to be overlapped with the latency of performing the granule protection check, and hence also reduces the time taken to access memory protected by the granule protection checking circuitry 50. However, this approach requires significantly less modification than an approach in which the target data is returned to the registers of a requester in advance of the granule protection check completing. In particular, for the requester to access the data from the cache a demand access request may need to be issued which itself needs to pass the granule protection checks (as all access requests may be subject to checking by the granule protection checking circuitry 50), and hence the data may not be accessed from the cache until a granule protection check has been completed. Hence, there is no requirement to provide complex circuitry for preventing the target data from being used until after the granule protection check.

In some examples, the prefetch circuitry 56 may be provided by the address translation circuitry 28. In response to a demand access request specifying a VA, the address translation circuitry 28 may translate the VA to determine a PA. The address translation circuitry 28 may then obtain granule protection information and initiate a granule protection check on the basis of the PA to determine whether the PA is permitted to access the target granule of physical addresses. The address translation circuitry 28 may simultaneously cause the prefetch circuitry 56 to initiate a prefetch operation to fetch target data (e.g., data or instructions) corresponding to the PA into a cache 8, 30, 32. Once the granule protection check has completed, the address translation circuitry 28 may return an address translation response indicating the PA and the outcome of the GPC. The LSU 26 may use the translated address to access the target data from the memory system, and in doing so may access the target data retrieved into the cache 8, 30, 32 by the prefetch circuitry 56.

In an alternative example, the address translation circuitry 28 may translate the VA to a PA, and initiate the GPC on the basis of the translated PA (and PAS). Rather than triggering the prefetch operation itself, the address translation circuitry 28 may, before the outcome of the GPC is known, return the translated PA to the processing circuitry 4 as a partial address translation response. The translated PA may for example be cached in a TLB associated with the processing circuitry 4, and the entry may for example indicate that the GPC outcome is not yet known for the entry. In response to memory access requests specifying a VA which matches an entry for which the GPC outcome is not known, prefetch circuitry within the processing circuitry, such as the load/store unit 26, may initiate the prefetch operation using the PA returned by the address translation circuitry 28 in the partial address translation response. Once the outcome of the GPC has been determined by the granule protection checking circuitry 50, a further response may be provided indicating the outcome. If the GPC passed, the partial TLB entry may be updated to a full TLB entry and in response to a future memory access request specifying a VA which matches a full TLB entry the load/store unit 26 may retrieve the target data in a demand access.

In some examples, the prefetch circuitry may be provided by a prefetch engine 54. The prefetch engine may generally issue prefetch requests to addresses predicted to be accessed in the future, for example based on monitoring patterns of memory accesses. The prefetch engine may issue a prefetch request specifying a VA to the address translation circuitry, which may provide a response indicating the translated PA in advance of the GPC completing. The prefetch engine 54 may use the translated PA to retrieve the target data into a cache 8, 30, 32 independently of whether the GPC has completed.

In some examples, memory accesses may be specified initially with a PA and hence not require address translation. In such cases, the prefetch operation may be triggered by prefetch circuitry either speculatively (e.g., in response to the prefetch engine 54 issuing a prefetch request) or in response to a detection that a GPC is required for a demand access request specifying a PA (in some examples, the prefetch circuitry could be provided by the granule protection checking circuitry 50).

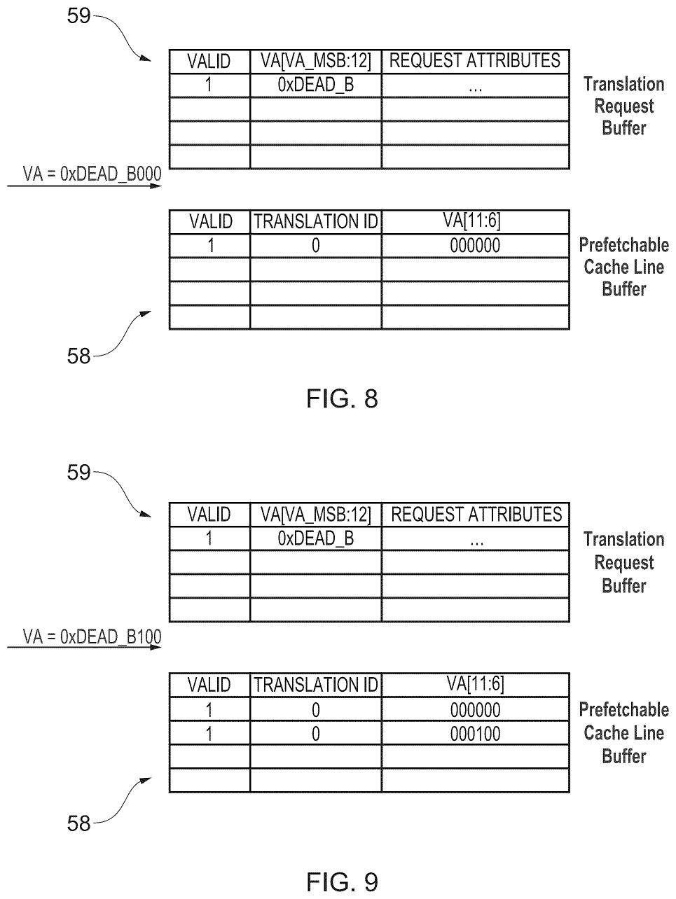

FIGS. 8 to 11 provide examples of a prefetchable cache line buffer which can be used to initiate a plurality of prefetch requests. The prefetchable cache line buffer 58 may for example be provided by address translation circuitry 56. The prefetchable cache line buffer 58 can allow prefetch operations to be combined and issued together for a plurality of memory locations in the same memory page, which may allow prefetch operations to be performed more efficiently if the memory page is accessed in one go, and can also allow the address translation circuitry to specify prefetch operations at the granularity of a cache line.

As shown in FIGS. 8 to 11, the address translation circuitry may have a translation request buffer 59 comprising entries to track virtual addresses for which memory access requests have been received by the translation circuitry 28 for translation to physical addresses. The translation request buffer (and prefetchable cache line buffer 58) may track entries corresponding to memory access requests which missed in the TLB 29 and hence require a page table walk for translation. The virtual addresses for translation may be indicated to the granularity of a virtual memory page (e.g., down to bit 12) as translation may take place at the page granularity. Hence, the translation request buffer may not track the offset bits for a given memory access request.

The prefetchable cache line buffer 58 also stores entries corresponding to memory access requests received by the translation circuitry. Entries of the prefetchable cache line buffer 58 may correspond to an entry in the translation request buffer 59. For example, the translation request buffer may provide the upper virtual address bits for a given memory access request and the prefetchable cache line buffer may provide the offset bits (e.g., bits 11 to 6) indicating the location of a cache line to be accessed within the memory page. Supporting tracking of the offset bits at the address translation circuitry 28 can allow prefetch operations to be initiated by the address translation circuitry 28 at the cache line granularity, and tracking these bits in a separate structure (rather than in the translation request buffer) may reduce modification of the translation request buffer 59.

The prefetchable cache line buffer 58 can also associate memory access requests in the same memory page. For example, the cache line buffer entries may provide memory page identifying information which can be used to associated entries in the prefetchable cache line buffer which are associated with the same memory page. These entries may also be associated with a single entry in the translation request buffer. The memory page identifying information could simply be the virtual address of the memory page (as provided in the translation request buffer 59) although a more efficient encoding can be provided if an ID is used to associate the prefetchable cache line buffer entries associated with a particular memory page to the corresponding entry of the translation request buffer 59 indicating the virtual address of that memory page. When prefetch requests are issued by the prefetch circuitry 56, the prefetch circuitry 56 may issue in one go prefetch requests for the group of virtual addresses associated with each other in the same memory page.

FIG. 8 illustrates the state of the translation request buffer 59 and the prefetchable cache line buffer 58 following receipt of a memory access request specifying the virtual address (indicated in hexadecimal) 0xDEAD_B000. A new entry may be allocated in the translation request buffer 59 to track the virtual page address 0xDEAD_B for translation, may track attributes associated with the request (e.g., if it is a load or store request). A new entry may also be allocated in the prefetchable cache line buffer 58 indicating the offset bits (000000) for the request, identifying the cache line to be accessed within the virtual memory page.

FIG. 9 illustrates receipt of a subsequent memory access request specifying the virtual address 0xDEAD_B100. This address is in the same virtual memory page as the previous address, and hence no new entries are allocated in the translation request buffer 59 as there is already an entry in that buffer tracking the virtual address to be translated. However, a new entry is allocated in the prefetchable cache line buffer indicating the offset bits (000100) identifying the cache line to be accessed within the virtual memory page. Both entries in the prefetchable cache line buffer 58 in the example of FIG. 9 are associated with the same translation ID (0) as they correspond to the same entry of the translation request buffer and hence the same virtual page address.

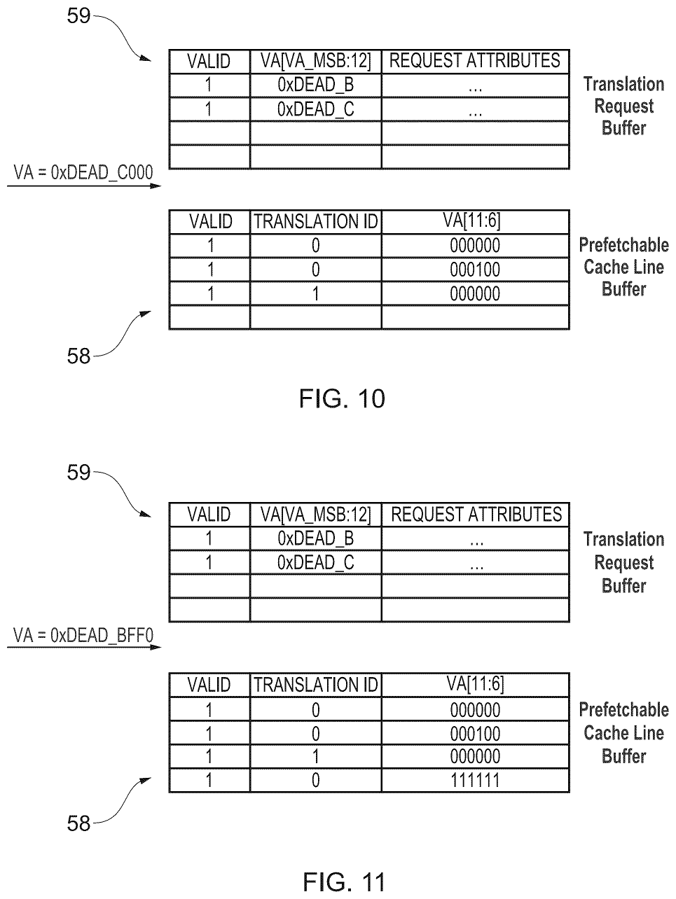

FIG. 10 illustrates receipt of a subsequent memory access request specifying the virtual address 0xDEAD_C000. This address is in a different virtual memory page to the previous requests, and hence a new entry is allocated in the translation request buffer 59 tracking the virtual address to be translated. A new entry is also allocated in the prefetchable cache line buffer indicating the offset bits (000000) identifying the cache line to be accessed within the virtual memory page. As the new entry corresponds to a different virtual memory page from the previously allocated entries, the new entry has a different translation identifier (1) from the previous entries, indicating that that this entry corresponds to the second entry in the translation request buffer 59.

Finally, FIG. 11 illustrates receipt of a subsequent memory access request specifying the virtual address 0xDEAD_BFF0. This address is in the same virtual memory page as the addresses of FIGS. 8 and 9, and hence no new entries are allocated in the translation request buffer 59 as there is already an entry in that buffer tracking the virtual address to be translated. A new entry is allocated in the prefetchable cache line buffer indicating the offset bits (111111) identifying the cache line to be accessed within the virtual memory page. The new entry in the prefetchable cache line buffer 58 in the example of FIG. 11 is associated with the same translation ID (0) as the entries allocated in FIGS. 8 and 9 as they all correspond to the same entry (the first entry) of the translation request buffer 59 and hence the same virtual page address.

The address translation circuitry 28 may process translation requests from the translation request buffer 59 in some order (e.g., the order of receipt). When the address translation circuitry 28 translates the virtual memory page address from a given entry in the translation request buffer 59, the prefetchable cache line buffer may be looked up to determine which entries of the prefetchable cache line buffer 59 correspond to the virtual page address being translated. For example, a lookup may determine which entries have translation IDs corresponding to the translated entry of the translation request buffer 59, or if the prefetchable cache line buffer stores (at least a portion of) a virtual page address, it may be determined which entries are associated with the same virtual page address as being translated. A set of prefetchable cache line buffer entries corresponding to the same virtual memory page can therefore be obtained.

Once the address translation circuitry 28 has obtained a translated physical page address (from a page table entry corresponding to the virtual page address), prefetch circuitry 56 may issue a number of prefetch requests corresponding to the set of prefetchable cache line buffer entries. In particular, the offset provided by each entry in the identified set may be combined with the translated physical page address to obtain a set of physical addresses at the granularity of a cache line, all belonging to the same physical page, which may be used to issue a plurality of prefetch requests. In the example of FIG. 11, if the virtual page address 0xDEAD_B is translated to the physical page address 0x8888, then prefetch requests may be issued to the physical addresses 0x888_8000, 0x888_8100, and 0x888_8FF0, for example.

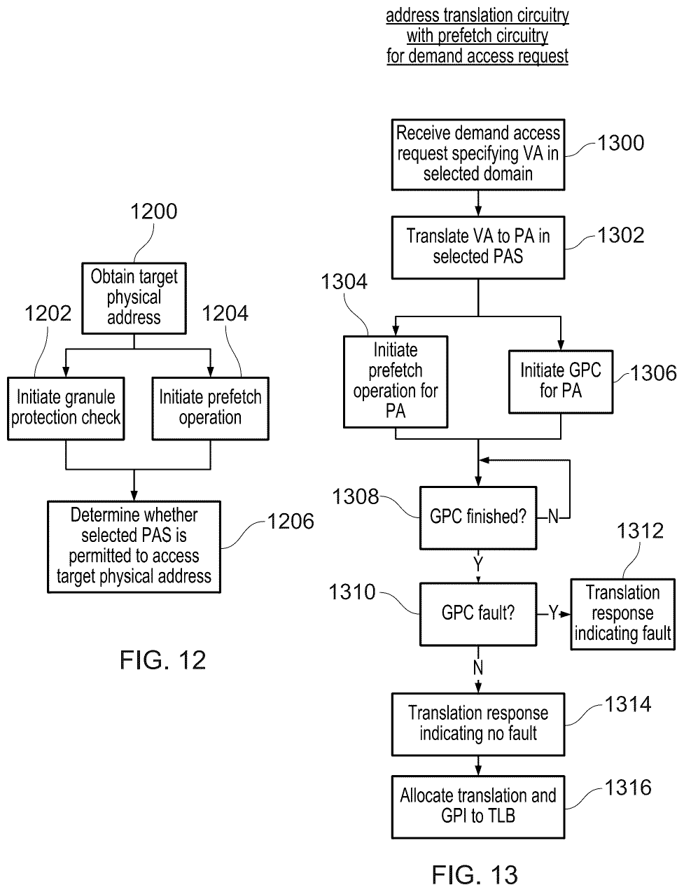

FIG. 12 is a flow diagram illustrating a method of issuing prefetch requests for memory locations protected by granule protection checking circuitry 50. At step 1200 a target physical address is obtained for a memory access request. The memory access request may be a demand access request, or may be a prefetch request. The target physical address may be obtained from the access request itself (directly specifying a PA) or from address translation circuitry 28 translating a VA specified by the memory access request into a PA (and, for translation at the page granularity, combining the translated PA with offset bits from the specified VA).

At step 1202, the obtained PA is used to initiate a granule protection check. The granule protection check involves determining which PAS is associated with the PA obtained at step 1200. For example, this may be based on one or more PAS identifying bits in the PA, or based on which domain the PA was issued in, as shown in FIG. 7. The granule protection check then involves determining whether the PAS is permitted to access the target granule of physical addresses comprising the PA. This check is based on an entry of a granule protection table (GPT) associated with the target granule of physical addresses, which may be obtained based on the target PA, and which indicates which PASs are allowed to access the target granule of physical addresses. Hence, initiating the granule protection check at step 1202 may comprise obtaining the granule protection information corresponding to the target PA.

At a timing independent of the progress of the granule protection check, a prefetch operation is initiated at step 1204 to retrieve target data at the memory location identified by the PA into a cache, such as a L1 data cache, L1 instruction cache, or L2 cache, for example.

Once the granule protection information has been obtained, at step 1206 the retrieved granule protection information is used to determine whether the selected PAS is permitted to access the target granule of physical addresses comprising the target PA.

Hence it will be appreciated that the latency of performing the GPC can be overlapped with the latency of obtaining the target data from memory, without compromising the security of the system or requiring complex logic for monitoring which data values can be accessed at a given time. Although FIG. 12 shows steps 1202 and 1204 being performed at the same time, it will be appreciated that the timing of these steps is unrelated to each other and either step may be performed before the other. In addition, the timings of steps 1204 and 1206 are unrelated, and in some cases the granule protection check may complete before the prefetch operation is completed.

FIG. 13 is a flow diagram illustrating a method performed by address translation circuitry 28 comprising prefetch circuitry 56 in response to a demand access request.

At step 1300, the address translation circuitry receives a translation request, corresponding to a demand access request, from a requester. The request specifies a target virtual address (VA) at the granularity of a cache line (i.e., including offset bits) and is issued in a particular domain. Although not indicated in FIG. 13, at this step the request may be added to a translation request buffer 59 and prefetchable cache line buffer 58 if the translation is not provided in a TLB entry.

At step 1302, when the target VA is translated, e.g., if it is the next address in the translation request buffer 59, the address translation circuitry translates the target VA to a target physical address in a selected physical address space. Requests in the translation request buffer may have already missed in a TLB and hence this translation may involve a page table walk to obtain page table information from memory.

After the target PA has been obtained, at step 1304 a prefetch operation is initiated to retrieve target data corresponding to the target PA into a cache. This may involve combining offset bits from the target VA with the translated physical page address to determine a target PA at the granularity of a cache line for prefetching. At this stage, several prefetch requests may be issued to memory if there are a plurality of entries in the prefetchable cache line buffer 58 corresponding to the target virtual memory page.

Independently from the initiation of the prefetch operation, at step 1306 a granule protection check is initiated for the target PA in the selected PAS (e.g., as described with reference to step 1202).

At step 1308 it is determined whether the granule protection check has finished. If so, then at step 1310 it is determined whether the selected PAS is permitted to access the target granule of physical addresses comprising the target PA.

If the selected PAS is not permitted to access the target granule of physical addresses comprising the target PA., then at step 1312 an address translation response is provided to the requester indicating that there was a granule protection fault.

If the selected PAS is permitted to access the target granule of physical addresses comprising the target PA, then at step 1314 an address translation response is provided to the requester indicating that there was no granule protection fault and including the translated PA (at the granularity of the memory page). The translation response and result of the granule protection check can be allocated to a TLB so that a future memory access request can be handled more quickly.

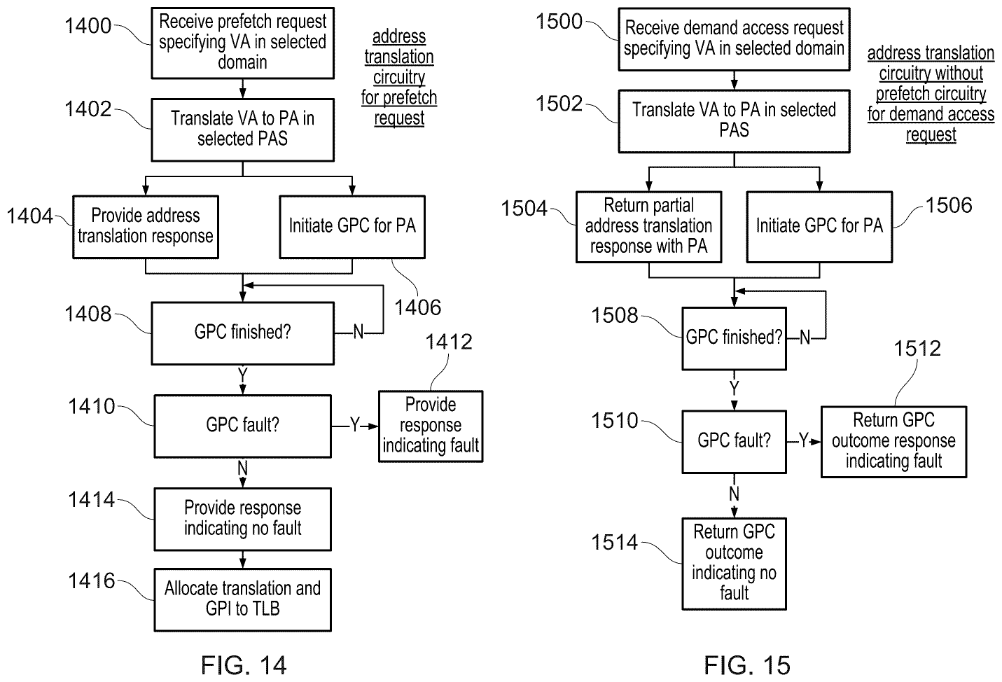

FIG. 14 is a flow diagram illustrating a method performed by address translation circuitry 28 in response to a prefetch request.

At step 1400, the address translation circuitry receives a translation request, corresponding to a prefetch request issued by a prefetch engine 54. The request specifies a target virtual address (VA) and is issued in a particular domain.

At step 1402, when the target VA is translated, e.g., if it is the next address in the translation request buffer 59, the address translation circuitry translates the target VA to a target physical address in a selected physical address space.

After the target PA has been obtained, at step 1404 an address translation response is provided (e.g., to the prefetch engine) indicating the translated PA. This allows the prefetch engine to initiate a prefetch operation to retrieve the target data into a cache even before the result of the GPC is known. In the method of FIG. 14 the address translation response is returned before the GPC has completed while in the method of FIG. 13 the address translation response is returned after the GPC, and hence the same address translation circuitry may be configured to provide an address translation response at different times depending on the type of request.

Independently from sending the address translation response, at step 1406 a granule protection check is initiated for the target PA in the selected PAS (e.g., as described with reference to step 1202).

At step 1408 it is determined whether the granule protection check has finished. If so, then at step 1410 it is determined whether the selected PAS is permitted to access the target granule of physical addresses comprising the target PA.

If the selected PAS is not permitted to access the target granule of physical addresses comprising the target PA., then at step 1412 a further response may be provided indicating that there was a granule protection fault. If the selected PAS is permitted to access the target granule of physical addresses comprising the target PA, then at step 1414 an address translation response is provided indicating that there was no granule protection fault and including the translated PA (at the granularity of the memory page). The translation response and result of the granule protection check can be allocated to a TLB so that a future memory access request can be handled more quickly. Hence, continuing the GPC for a prefetch request, even after an address translation response has been provided, can be useful to enable the results of the GPC to be cached in a TLB to allow future memory access requests to be handled more quickly.

FIG. 15 is a flow diagram illustrating a method performed by address translation circuitry 28 which does not provide prefetch circuitry 56, in response to a demand access request.

Steps 1500 and 1502 are the same as steps 1300 and 1302.

At step 1504, as the address translation circuitry 28 does not provide prefetch circuitry 565 it cannot initiate a prefetch operation. Instead, a partial address translation response is returned to the requester at step 1504 providing a physical address translation of the target virtual address (at least at the granularity of a memory page, no need for the address translation circuitry to consider offset bits) but without providing an outcome of the granule protection check.

Independently from issuing the partial address translation response, at step 1506 a granule protection check is initiated for the target PA in the selected PAS (e.g., as described with reference to step 1202).

At step 1508 it is determined whether the granule protection check has finished. If so, then at step 1510 it is determined whether the selected PAS is permitted to access the target granule of physical addresses comprising the target PA.

If the selected PAS is not permitted to access the target granule of physical addresses comprising the target PA., then at step 1512 a response is provided to the requester indicating that there was a granule protection fault. This response can allow the requester to internally indicate that the translated PA cannot be used to access the target data in the selected PAS, or for example can allow the requester to invalidate any translation of the PA in the selected PAS (as this will not be a useful translation).

If the selected PAS is permitted to access the target granule of physical addresses comprising the target PA, then at step 1514 a response is provided to the requester indicating that there was no granule protection fault. This can allow the requester to internally indicate that the target PA can be used to access the target data in the selected PAS, and may for example allow the requester to internally cache the translation for future memory access requests.

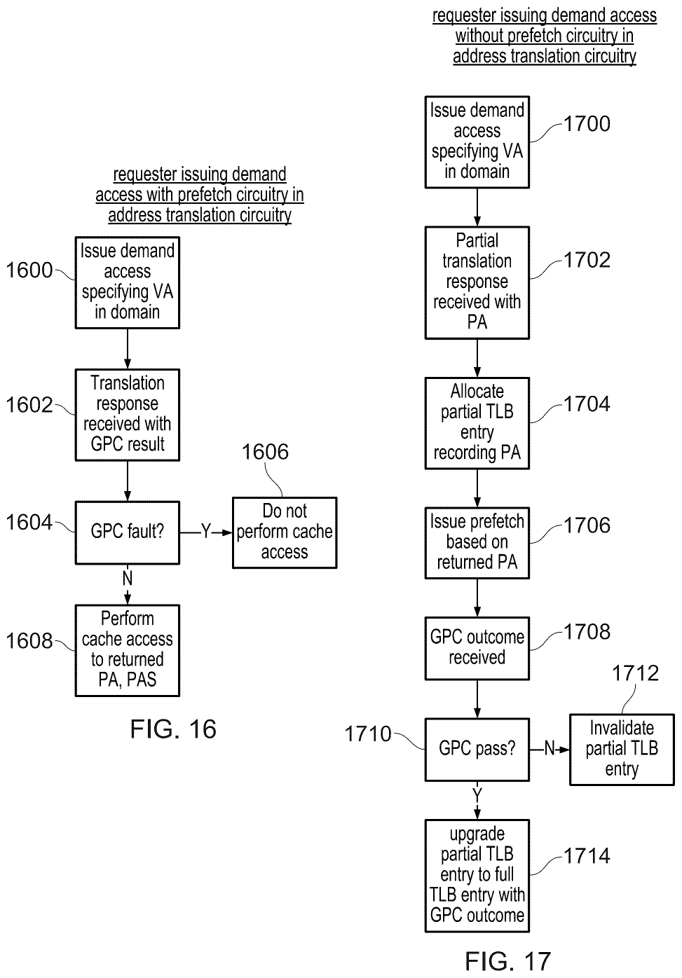

FIG. 16 is a flow diagram illustrating a method performed by a requester 40 responsible for issuing a demand access request to address translation circuitry 28 having prefetch circuitry 56.

At step 1600 an address translation request is issued, for a demand access request, to the address translation circuitry 28 specifying a VA issued in a particular domain. The address translation circuitry handles the request as illustrated in FIG. 13.

At step 1602 a translation response is received from the address translation circuitry providing the translated PA and an outcome of the GPC.

At step 1604 it is determined whether there was a granule protection fault. If so, then the translated PA is unable to access the target data in the selected PAS and hence at step 1606 no further memory access is performed.

If at step 1604 it is determined that there is no granule protection fault and hence the selected PAS is permitted to access the target granule of PAs, then at step 1608 the demand access request may be replayed to the micro TLB (a local copy of address translation information provided at the load/store unit 26 of fetch stage 6) storing the address translation, hit in the micro TLB, and hence trigger a cache access to access the target data.

The cache access may hit against the target data in the cache (if the prefetch operation has already completed) and hence allow the target data to be accessed more quickly than if the prefetch operation had not been performed. If the prefetch operation has not yet completed, the demand access request may be merged with the prefetch operation (this may still enable the data to be obtained sooner than if the prefetch operation had not been started at all).

FIG. 17 is a flow diagram illustrating a method performed by a requester 40 responsible for issuing a demand access request to address translation circuitry 28 which does not have prefetch circuitry 56.

At step 1700 an address translation request is issued, for a demand access request, to the address translation circuitry 28 specifying a VA issued in a particular domain. The address translation circuitry handles the request as illustrated in FIG. 15.

At step 1702 a partial address translation response is received from the address translation circuitry providing the translated PA, but without providing an outcome of the GPC.

At step 1704 a partial TLB entry may be allocated (e.g., in a micro TLB local to a LSU 26 or fetch circuitry 6 of the requester) recording the address translation but without recording the GPC outcome. The partial TLB entry may only be used to initiate prefetch requests, and not demand access requests because it is not yet known if the target data can be accessed by the PA in the selected PAS.

At step 1706 the requester initiates a prefetch operation based on the PA returned in the partial address translation response. For example, the demand access request may be replayed and hit against the partial entry in the micro TLB to cause the prefetch operation to be initiated to the target PA.

At step 1708 the outcome of the granule protection check is received from the address translation circuitry 28 or granule protection checking circuitry 50. At step 1710 it is determined whether there was a granule protection fault. If so, then the translated PA is unable to access the target data in the selected PAS and hence at step 1712 the partial TLB entry allocated for the translated PA is invalidated as it is not a useful translation.

If at step 1710 it is determined that there is no granule protection fault and hence the selected PAS is permitted to access the target granule of PAs, then at step 1714 the partial TLB entry may be upgraded to a full TLB entry recording the PA and the outcome of the GPC.

Hence, in response to a future demand access request (e.g., a replay of the demand access request issued at step 1700), a cache access request may be issued to the PA to access the target data. The cache access may hit against the target data in the cache (if the prefetch operation initiated at step 1706 has already completed) and hence allow the target data to be accessed more quickly than if the prefetch operation had not been performed and the data had not been requested until after the GPC outcome was received. If the prefetch operation has not yet completed, the demand access request may be merged with the prefetch operation.

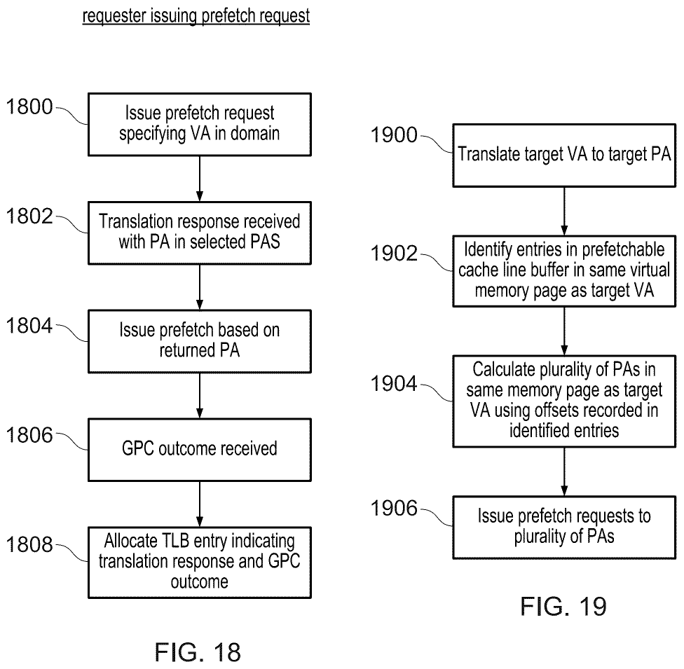

FIG. 18 is a flow diagram illustrating a method performed by a prefetch engine 54 issuing a prefetch request.

At step 1800 a prefetch request is issued specifying a virtual address. An address translation request is issued to address translation circuitry to request a translated physical address for the prefetch request. The prefetch request may be issued speculatively, for example in response to a prediction that the target virtual address will be accessed by a future demand access instruction and hence performance may be improved by prefetching the target data into a cache. The address translation circuitry handles the request according to the method of FIG. 14.

At step 1802, the prefetch circuitry receives an address translation response providing a translated PA corresponding to the target VA, on the basis of which the prefetch engine initiates a prefetch operation to retrieve the target data into a cache at step 1804 (e.g., by replaying the prefetch request and hitting against an entry in a micro TLB local to the prefetch engine and storing the returned PA).

At step 1806, independent of the timing of the prefetch operation, a GPC outcome response is provided by the address translation circuitry 28 or granule protection checking circuitry 50 and may be used at step 1808 to allocate an entry in a TLB to cache the outcome of the GPC for the translated PA in the selected PAS.

FIG. 19 is a flow diagram illustrating a method performed by address translation circuitry 28 comprising prefetch circuitry 56, of issuing prefetch requests to a set of target physical addresses using a prefetchable cache line buffer 58.

At step 1900, the address translation circuitry 28 translates a target VA (e.g., from a demand access request or prefetch request) to a target PA in a selected PAS.

At step 1902, a lookup is performed in the prefetchable cache line buffer 58 to identify a set of entries corresponding to the same virtual memory page as the target VA (and hence the same physical memory page as the target PA).

At step 1904 a physical address is calculated for each of the entries identified in step 1902. In particular, the offset bits indicated in each entry are added to the physical memory page address determined in step 1900 to determine a plurality of physical addresses in the same memory page at a cache line granularity.

At step 1906 the addresses calculated in step 1904 are used to issue a plurality of prefetch requests to retrieve, into a cache, target data corresponding to a plurality of access requests in the address translation queue belonging to the same memory page.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

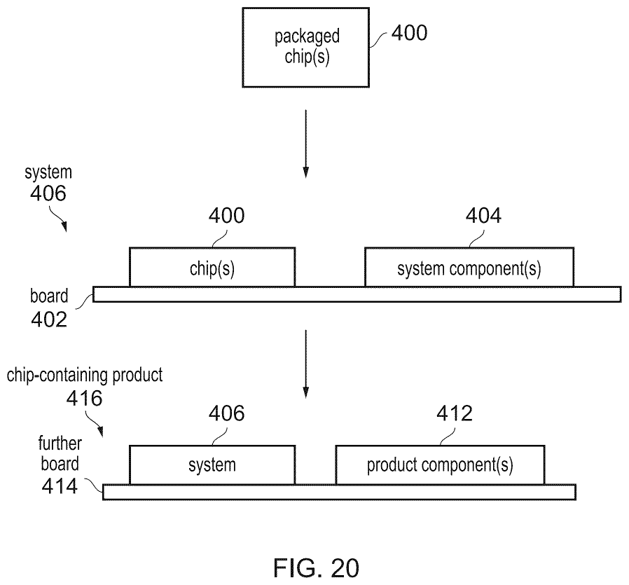

As shown in FIG. 20, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus, comprising:
granule protection checking circuitry configured to:
   perform a granule protection lookup based on a target physical address to obtain granule protection information associated with a target granule of physical addresses comprising the target physical address; and
   determine, based on the granule protection information, whether a selected physical address space associated with the target physical address and selected from among a plurality of physical address spaces is permitted to access the target granule of physical addresses; and
prefetch circuitry configured to initiate a prefetch operation for the target physical address enabling target data identified by the target physical address to be prefetched into a cache in advance of the granule protection checking circuitry determining whether the selected physical address space is permitted to access the target granule of physical addresses.

2. The apparatus according to clause 1, comprising address translation circuitry responsive to a memory access request specifying a target virtual address to translate the target virtual address into the target physical address associated with the selected physical address space.

3. The apparatus according to clause 2, wherein the address translation circuitry is responsive to a demand memory access request, the demand memory access request requesting that target data associated with the target virtual address is returned to a requester, to control the prefetch circuitry to initiate the prefetch operation for the target physical address.

4. The apparatus according to clause 3, wherein the granule protection checking circuitry is configured to prohibit the target data being returned to the requester in response to determining that the selected physical address space is not permitted to access the target granule of physical addresses.

5. The apparatus according to any of clauses 3 and 4, wherein the address translation circuitry is configured to provide the prefetch circuitry with one or more offset bits identifying an offset of the target physical address within a memory page.

6. The apparatus according to any of clauses 3 to 5, comprising a prefetchable cache line buffer configured to store a plurality of prefetchable cache line entries, each prefetchable cache line entry identifying, for a given demand memory access request pending translation:
at least an offset portion of a given target virtual address specified by the given demand memory access request, the offset portion identifying an offset of the given target virtual address within a memory page, and
memory page identifying information for associating prefetchable cache line entries for which the target virtual addresses belong to the same memory page;
wherein the address translation circuitry is configured to initiate a plurality of prefetch operations to target physical addresses determined based on the offset portion of target virtual addresses identified, based on the memory page identifying information, as corresponding to the same memory page.

7. The apparatus according to clause 6, wherein the memory page identifying information is specified using fewer bits than a portion of the target virtual address identifying the virtual memory page.

8. The apparatus according to any of clauses 3 to 7, wherein the address translation circuitry comprises a prefetch disabled mode in which the address translation circuitry is configured to suppress controlling the prefetch circuitry to initiate the prefetch operation.

9. The apparatus according to any of clauses 3 to 8, wherein the address translation circuitry is configured to indicate to the prefetch circuitry whether the demand memory access request is a load request or a store request when controlling the prefetch circuitry to initiate the prefetch operation for the target physical address.

10. The apparatus according to clause 2, wherein:
the address translation circuitry is responsive to a demand memory access request, the demand memory access request requesting that target data associated with the target virtual address is returned to a requester, to return a partial address translation response indicating the target physical address in advance of the granule protection checking circuitry determining whether the selected physical address space is permitted to access the target granule of physical addresses; and
the prefetch circuitry is configured to initiate, based on the partial address translation response, the prefetch operation for the target physical address corresponding to the demand memory access request.

11. The apparatus according to clause 10, wherein the address translation circuitry is responsive to the granule protection checking circuitry determining whether the selected physical address space is permitted to access the target granule of physical addresses to return a granule protection check outcome response;
the granule protection check outcome response indicating whether the selected physical address space is permitted to access the target granule of physical addresses.

12. The apparatus according to any preceding clause, wherein the prefetch circuitry is configured to initiate the prefetch operation speculatively in response to a prediction that the target data will be requested by a future demand memory access request, the prefetch operation comprising a request to retrieve the target data associated with the target physical address into the cache without being returned to a requester.

13. The apparatus according to any of clauses 2 to 12, comprising a translation lookaside buffer configured to cache address mapping information used by the address translation circuitry for translating the target virtual address into the target physical address, wherein the granule protection checking circuitry is configured to perform the granule protection lookup and store the identified granule protection information in the translation lookaside buffer, regardless of whether the prefetch circuitry has initiated the prefetch operation for the target physical address.

14. The apparatus according to any preceding clause, comprising a point of physical aliasing (PoPA) memory system component configured to de-alias a plurality of aliasing physical addresses from different physical address spaces which correspond to a same memory system location, to map any of the plurality of aliasing physical addresses to a de-aliased physical address to be provided to at least one downstream memory system component; and
at least one pre-PoPA memory system component provided upstream of the PoPA memory system component, where the at least one pre-PoPA memory system component is configured to treat the aliasing physical addresses from different physical address spaces as if the aliasing physical addresses correspond to different memory system locations.

15. The apparatus according to any preceding clause, comprising physical address space selection circuitry to select the selected physical address space for the target physical address based on at least one of:
a current domain of operation; and
information specified in a page table entry that also provides address mapping information used by address translation circuitry for translating a target virtual address into the target physical address.

16. The apparatus according to clause 15, comprising processing circuitry to process instructions in one of a plurality of domains of operation, the plurality of domains of operation including at least a non-secure domain, a secure domain, a realm domain and a root domain;
the plurality of physical address spaces comprising:
   a root physical address space selectable as the selected physical address space when a current domain of the processing circuitry is the root domain;
   a non-secure physical address space selectable as the selected physical address space when the current domain of the processing circuitry is any of the non-secure domain, the secure domain, the realm domain and the root domain;
   a secure physical address space selectable as the selected physical address space when the current domain of the processing circuitry is the secure domain or the root domain; and
   a realm physical address space selectable as the selected physical address space when the current domain of the processing circuitry is the realm domain or the root domain.

17. A system comprising:
the apparatus of any preceding clause, implemented in at least one packaged chip;
at least one system component; and
a board,
wherein the at least one packaged chip and the at least one system component are assembled on the board.

18. A chip-containing product comprising the system of clause 17, wherein the system is assembled on a further board with at least one other product component.

19. A method, comprising:
performing a granule protection lookup based on a target physical address to identify granule protection information associated with a target granule of physical addresses comprising the target physical address;
determining, based on the granule protection information, whether a selected physical address space associated with the target physical address and selected from among a plurality of physical address spaces is permitted to access the target granule of physical addresses; and
initiating, in advance of the granule protection checking circuitry determining whether the selected physical address space is permitted to access the target granule of physical addresses, a prefetch operation for the target physical address enabling target data identified by the target physical address to be prefetched into a cache.

20. Computer-readable code for fabrication of an apparatus, comprising:
granule protection checking circuitry configured to:
perform a granule protection lookup based on a target physical address to identify granule protection information associated with a target granule of physical addresses comprising the target physical address; and
determine, based on the granule protection information, whether a selected physical address space associated with the target physical address and selected from among a plurality of physical address spaces is permitted to access the target granule of physical addresses; and
prefetch circuitry configured to initiate a prefetch operation for the target physical address enabling target data identified by the target physical address to be prefetched into a cache in advance of the granule protection checking circuitry determining whether the selected physical address space is permitted to access the target granule of physical addresses.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
granule protection checking circuitry configured to:
perform a granule protection lookup based on a target physical address to obtain granule protection information associated with a target granule of physical addresses comprising the target physical address; and
determine, based on the granule protection information, whether a selected physical address space associated with the target physical address and selected from among a plurality of physical address spaces is permitted to access the target granule of physical addresses; and
prefetch circuitry configured to initiate a prefetch operation for the target physical address enabling target data identified by the target physical address to be prefetched into a cache in advance of the granule protection checking circuitry determining whether the selected physical address space is permitted to access the target granule of physical addresses.

2. The apparatus according to claim 1, comprising address translation circuitry responsive to a memory access request specifying a target virtual address to translate the target virtual address into the target physical address associated with the selected physical address space.

3. The apparatus according to claim 2, wherein the address translation circuitry is responsive to a demand memory access request, the demand memory access request requesting that target data associated with the target virtual address is returned to a requester, to control the prefetch circuitry to initiate the prefetch operation for the target physical address.

4. The apparatus according to claim 3, wherein the granule protection checking circuitry is configured to prohibit the target data being returned to the requester in response to determining that the selected physical address space is not permitted to access the target granule of physical addresses.

5. The apparatus according to claim 3, wherein the address translation circuitry is configured to provide the prefetch circuitry with one or more offset bits identifying an offset of the target physical address within a memory page.

6. The apparatus according to claim 3, comprising a prefetchable cache line buffer configured to store a plurality of prefetchable cache line entries, each prefetchable cache line entry identifying, for a given demand memory access request pending translation:
at least an offset portion of a given target virtual address specified by the given demand memory access request, the offset portion identifying an offset of the given target virtual address within a memory page, and
memory page identifying information for associating prefetchable cache line entries for which the target virtual addresses belong to the same memory page;
wherein the address translation circuitry is configured to initiate a plurality of prefetch operations to target physical addresses determined based on the offset portion of target virtual addresses identified, based on the memory page identifying information, as corresponding to the same memory page.

7. The apparatus according to claim 6, wherein the memory page identifying information is specified using fewer bits than a portion of the target virtual address identifying the virtual memory page.

8. The apparatus according to claim 3, wherein the address translation circuitry comprises a prefetch disabled mode in which the address translation circuitry is configured to suppress controlling the prefetch circuitry to initiate the prefetch operation.

9. The apparatus according to claim 3, wherein the address translation circuitry is configured to indicate to the prefetch circuitry whether the demand memory access request is a load request or a store request when controlling the prefetch circuitry to initiate the prefetch operation for the target physical address.

10. The apparatus according to claim 2, wherein:
the address translation circuitry is responsive to a demand memory access request, the demand memory access request requesting that target data associated with the target virtual address is returned to a requester, to return a partial address translation response indicating the target physical address in advance of the granule protection checking circuitry determining whether the selected physical address space is permitted to access the target granule of physical addresses; and
the prefetch circuitry is configured to initiate, based on the partial address translation response, the prefetch operation for the target physical address corresponding to the demand memory access request.

11. The apparatus according to claim 10, wherein the address translation circuitry is responsive to the granule protection checking circuitry determining whether the selected physical address space is permitted to access the target granule of physical addresses to return a granule protection check outcome response;
the granule protection check outcome response indicating whether the selected physical address space is permitted to access the target granule of physical addresses.

12. The apparatus according to claim 1, wherein the prefetch circuitry is configured to initiate the prefetch operation speculatively in response to a prediction that the target data will be requested by a future demand memory access request, the prefetch operation comprising a request to retrieve the target data associated with the target physical address into the cache without being returned to a requester.

13. The apparatus according to claim 2, comprising a translation lookaside buffer configured to cache address mapping information used by the address translation circuitry for translating the target virtual address into the target physical address, wherein the granule protection checking circuitry is configured to perform the granule protection lookup and store the identified granule protection information in the translation lookaside buffer, regardless of whether the prefetch circuitry has initiated the prefetch operation for the target physical address.

14. The apparatus according to claim 1, comprising a point of physical aliasing (PoPA) memory system component configured to de-alias a plurality of aliasing physical addresses from different physical address spaces which correspond to a same memory system location, to map any of the plurality of aliasing physical addresses to a de-aliased physical address to be provided to at least one downstream memory system component; and
at least one pre-PoPA memory system component provided upstream of the PoPA memory system component, where the at least one pre-PoPA memory system component is configured to treat the aliasing physical addresses from different physical address spaces as if the aliasing physical addresses correspond to different memory system locations.

15. The apparatus according to claim 1, comprising physical address space selection circuitry to select the selected physical address space for the target physical address based on at least one of:
a current domain of operation; and
information specified in a page table entry that also provides address mapping information used by address translation circuitry for translating a target virtual address into the target physical address.

16. The apparatus according to claim 15, comprising processing circuitry to process instructions in one of a plurality of domains of operation, the plurality of domains of operation including at least a non-secure domain, a secure domain, a realm domain and a root domain;
the plurality of physical address spaces comprising:
a root physical address space selectable as the selected physical address space when a current domain of the processing circuitry is the root domain;
a non-secure physical address space selectable as the selected physical address space when the current domain of the processing circuitry is any of the non-secure domain, the secure domain, the realm domain and the root domain;
a secure physical address space selectable as the selected physical address space when the current domain of the processing circuitry is the secure domain or the root domain; and
a realm physical address space selectable as the selected physical address space when the current domain of the processing circuitry is the realm domain or the root domain.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method, comprising:
performing a granule protection lookup based on a target physical address to identify granule protection information associated with a target granule of physical addresses comprising the target physical address;
determining, based on the granule protection information, whether a selected physical address space associated with the target physical address and selected from among a plurality of physical address spaces is permitted to access the target granule of physical addresses; and
initiating, in advance of the granule protection checking circuitry determining whether the selected physical address space is permitted to access the target granule of physical addresses, a prefetch operation for the target physical address enabling target data identified by the target physical address to be prefetched into a cache.

20. A non-transitory computer-readable medium storing computer-readable code for fabrication of an apparatus, comprising:
granule protection checking circuitry configured to:
perform a granule protection lookup based on a target physical address to identify granule protection information associated with a target granule of physical addresses comprising the target physical address; and
determine, based on the granule protection information, whether a selected physical address space associated with the target physical address and selected from among a plurality of physical address spaces is permitted to access the target granule of physical addresses; and
prefetch circuitry configured to initiate a prefetch operation for the target physical address enabling target data identified by the target physical address to be prefetched into a cache in advance of the granule protection checking circuitry determining whether the selected physical address space is permitted to access the target granule of physical addresses.
